(19) United States
(12) Patent Application Publication
(10) Pub. No.: US 2026/0356731 A1
(43) Pub. Date: Nov. 12, 2026

(54) HIGH P2O5 COPPER-CONTAINING NEAR-INFRARED ABSORBING GLASS COMPOSITION AND PRODUCTS COMPRISING THE SAME FOR FILTER APPLICATIONS

(71) Applicant: CORNING INCOPORATED, CORNING, NY (US)

(72) Inventors: Jesse Kohl, Horseheads, NY (US); Cedrick Alexander O'Shaughnessy, Painted Post, NY (US)

(21) Appl. No.: 19/724,067

(22) Filed: Jun. 29, 2026

Related U.S. Application Data
(63) Continuation of application No. PCT/US2024/059750, filed on Dec. 12, 2024.
(60) Provisional application No. 63/619,851, filed on Jan. 11, 2024.
(60) Provisional application No. 63/725,089, filed on Nov. 26, 2024.

(51) Int. Cl. C03C 3/062; G02B 1/00; G02B 5/20

(52) U.S. Cl. CPC C03C 3/062; G02B 1/00; G02B 5/208

(57) ABSTRACT

High P₂O₅ copper containing near-infrared absorbing glass compositions, articles comprising the same, methods of making the same, and methods of using the same are provided. Such glass compositions include in mole percent on an oxide basis and by a fluorine content: P₂O₅: 45-70; SiO₂: 2-30; Al₂O₃: 4-12; Li₂O: 0-5.1; K₂O: 0.3-10; ZnO: 0-20; SrO: 0-7.4; CuO: 5-16; Sb₂O₃: 0-4; CeO₂: 0-2; total fluorine (F): 0-35. The combined concentration of RO is in a range from 0 to 23.4, and the combined concentration of R′₂O is in a range of from 0.3 to 14.3. RO is selected from MgO, CaO, SrO, BaO, and ZnO, and R′₂O is selected from Li₂O, Na₂O, and K₂O. The glass compositions have red-shifted cutoff wavelength and good transmittance of visible light and good absorbance in near-infrared wavelength ranges and are suitable for use as an optical filter for a camera.

### PRIORITY CLAIM AND CROSS-REFERENCE

This application is a bypass continuation of PCT/US2024/059750 filed Dec. 12, 2024, which claims the benefit of priority under 35 U.S.C. § 119 of U.S. Provisional Application No. 63/725,089 filed Nov. 26, 2024, and U.S. Provisional Application No. 63/619,851 filed Jan. 11, 2024, the content of each of which is incorporated herein by reference in its entirety.

### FIELD

The disclosure relates to glass compositions generally. More particularly, the disclosed subject matter relates to glass compositions having near-infrared (NIR) properties and suitable for use in light filter applications; articles comprising the glass compositions; and methods for making the same.

### BACKGROUND

Many light sources, including the sun, emit infrared and near-infrared (NIR) light. An IR or NIR filter, which is a color filter blocking the infrared or NIR light, are required in a color camera to achieve realistic colors in white light. The color spectrum seen by the human eye is quite limited compared to the spectrum seen by a charged-coupled device (CCD) camera. In the near infrared region of the spectrum, the difference in sensitivity is more significant. A CCD color camera in daylight without an IR filter will therefore see a significant amount of infrared light resulting in strange colors. An IR filter cuts away a significant amount of the overall collected light and thereby affects the sensitivity in a negative way.

The spectral sensitivity of solid-state imaging elements such as CCDs employed in digital cameras runs from visible range to near-infrared range around 1,200 nm. Accordingly, filters absorbing light in near-infrared range are employed to obtain images approximating the visible sensitivity of humans.

### SUMMARY

The present disclosure provides a glass composition, a product comprising such a glass composition, methods of making the glass composition and the product, and methods of using the glass composition and the product. Such a glass composition is a near-infrared (NIR) absorbing glass. Such glass compositions exhibit desirable optical performance as described herein. The glass compositions are suitable for use as an optical filter in camera applications.

In one aspect, the present disclosure provides a glass or a glass composition. In accordance with some embodiments, a glass or a glass composition provided herein comprises in mole percent on an oxide basis and by a fluorine content:
P₂O₅: 45-70;
SiO₂: 2-30;
Al₂O₃: 4-12;
Li₂O: 0-5.1;
K₂O: 0.2-10;
ZnO: 0-20;
SrO: 0-7.4;
CuO: 5-16;
Sb₂O₃: 0-4;
CeO₂: 0-2;
total fluorine (F): 0-35;
wherein
a combined concentration of RO is in a range from 0 to 23.4,
a combined concentration of R′₂O is in a range of from 0.3 to 14.3,
RO is selected from the group consisting of MgO, CaO, SrO, BaO, and ZnO, and
R′₂O is selected from the group consisting of Li₂O, Na₂O, and K₂O.

In some embodiments, Al₂O₃, CuO, MgO, CaO, SrO, BaO, ZnO, Li₂O, Na₂O, and K₂O may be partially fluorinated, and the related oxide contents can be referred as oxide equivalents as described in the Detailed Description.

In some embodiments, the glass is substantially free of B, Na, Ba, and Cl. No related raw materials are added.

In some embodiments, P₂O₅ is in a suitable range. For example, P₂O₅ is in a range of from 45 to 70 by mole percent, in a range of from 46 to 70 by mole percent, in a range of from 47 to 70 by mole percent, in a range of from 47.5 to 69 by mole percent, in a range of from 48 to 69 by mole percent, in a range of from 49 to 69 by mole percent, in a range of from 50 to 69 by mole percent, in a range of from 51 to 69 by mole percent, in a range of from 52 to 69 by mole percent, in a range of from 50 to 68 by mole percent, in a range of from 51 to 68 by mole percent, in a range of from 52 to 68 by mole percent, or any other suitable range.

In some embodiments, SiO₂ is in a suitable range. For example, SiO₂ is in a range of from 2 to 30 by mole percent, in a range of from 3 to 30 by mole percent, in a range of from 4 to 30 by mole percent, in a range of from 4.5 to 29 by mole percent, in a range of from 4.5 to 28 by mole percent, in a range of from 4.5 to 27 by mole percent, in a range of from 4.5 to 26 by mole percent, in a range of from 4.5 to 25 by mole percent, in a range of from 4.75 to 28 by mole percent, in a range of from 4.75 to 27 by mole percent, in a range of from 4.75 to 26 by mole percent, in a range of from 4.75 to 25 by mole percent, or any other suitable range.

In some embodiments, Al₂O₃ is in a suitable range. For example, Al₂O₃ is in a range of from 4 to 12 by mole percent, in a range of from 3 to 11 by mole percent, in a range of from 3 to 10 by mole percent, in a range of from 4 to 8 by mole percent, in a range of from 4 to 7 by mole percent, in a range of from 4 to 6 by mole percent, in a range of from 3 to 6 by mole percent, in a range of from 2.5 to 5 by mole percent, in a range of from 3 to 5 by mole percent, in a range of from 3.5 to 4.5 by mole percent, or any other suitable range.

In some embodiments, CuO is in a suitable range. For example, CuO is in a range of from 5 to 16 by mole percent, in a range of from 6 to 16 by mole percent, in a range of from 6 to 15 by mole percent, in a range of from 6 to 14 by mole percent, in a range of from 7 to 16 by mole percent, in a range of from 7 to 15 by mole percent, in a range of from 7 to 14 by mole percent, or any other suitable range.

In some embodiments, the total fluorine is in a suitable range. For example, the total fluorine is in a range of from 0 to 35 by mole percent, in a range of from 1 to 32 by mole percent, in a range of from 2 to 30 by mole percent, in a range of from 3 to 29 by mole percent. in a range of from 4 to 28 by mole percent, in a range of from 5 to 27 by mole percent, in a range of from 6 to 26 by mole percent, in a range of from 6 to 25 by mole percent, in a range of from 10 to 25 by mole percent, in a range of from 10 to 22 by mole percent, in a range of from 10 to 20 by mole percent, or any other suitable range.

In some embodiments, RO is in a suitable range. For example, the combined concentration of RO is in a range of from 0 to 23.4 by mole percent, in a range of from 0 to 22 by mole percent, in a range of from 0 to 20 by mole percent, in a range of from 1 to 20 by mole percent, in a range of from 1.5 to 18 by mole percent, in a range of from 1.5 to 17 by mole percent, in a range of from 2 to 17 by mole percent, in a range of from 2 to 16 by mole percent, in a range of from 2 to 15 by mole percent, in a range of from 2 to 14 by mole percent, or any other suitable range.

In some embodiments, RO is selected from ZnO only or a combination of ZnO and SrO. The glass may be substantially free of BaO.

In some embodiments, ZnO is in a suitable range. For example, ZnO is in a range of from 0 to 20 by mole percent, in a range of from 0.25 to 20 by mole percent, in a range of from 0.5 to 18 by mole percent, in a range of from 0.5 to 17 by mole percent, in a range of from 0.75 to 16 by mole percent, in a range of from 0.75 to 15 by mole percent, in a range of from 0.75 to 14 by mole percent, or any other suitable ranges.

In some embodiments, SrO is in a suitable range. For example, SrO is in a range of from 0 to 7.4 by mole percent, in a range of from 0 to 7 by mole percent, in a range of from 0 to 6 by mole percent, in a range of from 0.25 to 7 by mole percent, in a range of from 0.25 to 6 by mole percent, in a range of from 0.5 to 6 by mole percent, in a range of from 0.5 to 5 by mole percent, in a range of from 0.75 to 5 by mole percent, in a range of from 0.75 to 4 by mole percent, or any other suitable ranges.

In some embodiments, R′₂O is in a suitable range. For example, the combined concentration of R′₂O is in a range of from 0.3 to 14.3 by mole percent, in a range of from 0.3 to 14 by mole percent, in a range of from 0.5 to 14 by mole percent, in a range of from 0.5 to 12 by mole percent, in a range of from 0.5 to 10 by mole percent, in a range of from 0.75 to 10 by mole percent, in a range of from 0.75 to 8 by mole percent, in a range of from 1 to 8 by mole percent, in a range of from 1 to 7 by mole percent, in a range of from 1 to 6 by mole percent, or any other suitable range.

In some embodiments, R′₂O is selected from Li₂O and K₂O and may be substantially free of Na₂O.

In some embodiments, Li₂O is in a suitable range. For example, Li₂O is in a range of from 1 to 5.1 by mole percent, in a range of from 0.1 to 5 by mole percent, in a range of from 0.2 to 5 by mole percent, in a range of from 0.2 to 4 by mole percent, in a range of from 0.3 to 4 by mole percent, in a range of from 0.3 to 3 by mole percent, or any other suitable range.

In some embodiments, K₂O is in a suitable range. For example, K₂O is in a range of from 0.2 to 10 by mole percent, in a range of from 0.2 to 8 by mole percent, in a range of from 0.2 to 6 by mole percent, in a range of from 0.2 to 5 by mole percent, in a range of from 0.3 to 5 by mole percent, in a range of from 0.4 to 5 by mole percent, in a range of from 0.4 to 4.5 by mole percent, in a range of from 0.5 to 5 by mole percent, in a range of from 0.6 to 4 by mole percent, or any other suitable range.

In some preferred embodiments, the glass or the glass composition comprises in mole percent on the oxide basis and by the fluorine content:
P₂O₅: 45-70;
SiO₂: 4-30;
Al₂O₃: 2.5-5.5;
Li₂O: 0.1-5;
K₂O: 0.2-5;
ZnO: 0.25-20;
SrO: 0.25-6;
CuO: 5-16;
Sb₂O₃: 0-3;
CeO₂: 0-2;
total fluorine (F): 2-30;
wherein
a combined concentration of RO is in a range from 1 to 20, and
a combined concentration of R′₂O is in a range of from 0.5 to 10.

In some more preferred embodiments, the glass or the glass composition comprises in mole percent on the oxide basis and by the fluorine content:
P₂O₅: 47.5-69;
SiO₂: 4-28;
Al₂O₃: 3-5;
Li₂O: 0.2-4;
K₂O: 0.4-4.5;
ZnO: 0.5-17;
SrO: 0.5-5;
CuO: 6-15;
Sb₂O₃: 0.1-0.3;
CeO₂: 0-1;
total fluorine (F): 6-25;
wherein
a combined concentration of RO is in a range from 1.5 to 17, and
a combined concentration of R′₂O is in a range of from 0.75 to 8.

In some other more preferred embodiments, the glass or the glass composition comprises in mole percent on the oxide basis and by the fluorine content:
P₂O₅: 52-68;
SiO₂: 4.75-25;
Al₂O₃: 3.5-4.5;
Li₂O: 0.3-3;
K₂O: 0.6-4;
ZnO: 0.75-14;
SrO: 0.75-4;
CuO: 7-14;
Sb₂O₃: 0.1-0.1;
CeO₂: 0.3-0.9;
total fluorine (F): 10-20;
wherein
a combined concentration of RO is in a range from 2 to 14, and
a combined concentration of R′₂O is in a range of from 1 to 6.

In some embodiments, the glass is substantially free of Sb₂O₃, which can be replaced with CeO₂, SnO₂, or other fining agents.

The glass and glass composition described herein have good optical performance. For example, the glass has a red-shifted cutoff wavelength with at least 50% transmittance at a thickness of 0.21 mm being at least 635 nm or longer. At the thickness of 0.21 mm, the glass has a transmittance higher than 85% at wavelengths in a range of 425-465 nm, a transmittance higher than 87% at wavelengths in a range of 466-560 nm, a transmittance lower than 5% at wavelengths in a range of 750-800 nm, and a transmittance lower than 10% at a wavelength of 1,200 nm.

In another aspect, a method for producing the glass or the glass composition as described herein is provided. Such a method comprises at least one step of mixing and melting raw materials in mole percent on an oxide basis and by the fluorine content so as to provide the oxides as described. Such a method may further comprise making a sheet comprising the glass composition through a suitable process. Examples of the raw material as the source for the total fluorine include, but are not limited to, AlF₃, SrF₂, ZnF₂, LiF, KF, and any combination thereof.

In another aspect, the present disclosure provides an article comprising the glass or the glass composition described herein. For example, an optical filter such as NIR filter comprises the glass or the glass composition described here. The filter is used for camera applications.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1 shows transmittance spectra of Examples 1 and 4-9 at 0.21 mm thickness.

FIG. 2 shows the effect of P₂O₅ concentration on the cutoff wavelength of the glass based on the results of Examples 1, 4, and 7 having 45 mol %, 55, mol %, and 65 mol % P₂O₅, respectively, and fixed SiO₂ concentration (5 mol %) and CuO concentration (8 mol %).

FIG. 3 shows the effect of SiO₂ concentration on the cutoff wavelength of the glass based on the results of Examples 7-9 including 5 mol %, 10, mol %, and 15 mol % SiO₂, respectively, and fixed P₂O₅ concentration (65 mol %) and CuO concentration (8 mol %).

FIG. 4 shows the optical transmittance spectra of Examples 10-18, which have SiO₂ at 5 mol % and 10 mol % and P₂O₅ concentrations that range from 55-70 mol % at three different CuO concentrations 8, 10, and 12 mol %, at a thickness of 0.21 mm.

FIG. 5 shows the optical transmittance spectra of Examples 19-27, which have SiO₂ of 15-25 mol % at two different CuO concentrations of 10 and 12 mol % and two different P₂O₅ concentrations of 55 mol % and 65 mol %, at a thickness of 0.21 mm.

FIG. 6 shows the cutoff wavelength as a function of the SiO₂ concentration in Examples 20, 22, and 24.

FIG. 7 shows the transmittance at 1,200 nm as a function of the SiO₂ concentration in Examples 20, 22, and 24.

FIG. 8 shows the optical transmittance spectra of Examples 28-33 at a thickness of 0.21 mm.

FIGS. 9-11 show the maximum visible transmittance (FIG. 9), the cutoff wavelength, and the transmittance at 1,200 nm as a function of Al₂O₃ concentration in silica-free glasses (Examples 28-30) and silica containing glasses (Examples 31-33).

FIG. 12 shows the transmission spectra of Example 40 (having 0.027 mol % Sb₂O₃) and Example 50 (Sb₂O₃-free) compared to Example 20 (having 0.3 mol % Sb₂O₃).

FIG. 13 shows the transmission spectra of Sb₂O₃-free Examples 46 and 48 compared to Sb₂O₃-containing Example 20.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

Open terms such as “include,” “including,” “contain,” “containing” and the like mean “comprising.” These open-ended transitional phrases are used to introduce an open ended list of elements, method steps or the like that does not exclude additional, unrecited elements or method steps. It is understood that wherever embodiments are described with the language “comprising,” otherwise analogous embodiments described in terms of “consisting of” and/or “consisting essentially of” are also provided.

The transitional phrase “consisting of” and variations thereof excludes any element, step, or ingredient not recited, except for impurities ordinarily associated therewith.

The transitional phrase “consists essentially of,” or variations such as “consist essentially of” or “consisting essentially of” excludes any element, step, or ingredient not recited except for those that do not materially change the basic or novel properties of the specified method, structure or composition.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

The terms “substantial,” “substantially,” and variations thereof as used herein are intended to note that a described feature is equal or approximately equal to a value or description. Moreover, “substantially similar” is intended to denote that two values are equal or approximately equal. In some embodiments, “substantially similar” may denote values within about 10% of each other, such as within about 5% of each other, or within about 2% of each other.

In some embodiments, the glass described herein may have any suitable shape. Examples of a glass include, but are not limited to, a flat or curved glass article such as an optical filter.

Unless expressly indicated otherwise, the term “glass article” or “glass” used herein is understood to encompass any object made wholly or partly of glass. Glass articles include monolithic substrates, glass substrates with a coating thereon, or laminates of glass and glass, glass and non-glass materials, glass and crystalline materials, and glass and glass-ceramics (which include an amorphous phase and a crystalline phase). Unless expressly indicated otherwise, the terms “glass” and “glass composition” used herein may be interchangeable.

Exemplary glass articles include, but are not limited to, a filter comprising a composition as described herein.

In the embodiments of the glass compositions described herein, the concentrations of constituent components (e.g., SiO₂, CuO, and the like) are specified in mole percent (mol. %) on an oxide basis, unless otherwise specified.

The terms “free” and “substantially free,” when used to describe the concentration and/or absence of a particular constituent component in a glass composition, means that the constituent component is not intentionally added to the glass composition. However, the glass composition may contain traces of the constituent component as a contaminant or tramp in amounts of less than 0.03 mol. % or less than 0.01 mol. %.

The term “softening point,” as used herein, refers to the temperature at which the viscosity of the glass composition is 1×10^{7.6} poise.

The term “annealing point,” as used herein, refers to the temperature at which the viscosity of the glass composition is 1×10¹³ poise.

The terms “strain point” and “Tₛₜᵣₐᵢₙ” as used herein, refers to the temperature at which the viscosity of the glass composition is 3×10¹⁴ poise.

The liquidus temperature of a glass (T_{liq}) is the temperature (°C) above which no crystalline phases can coexist in equilibrium with the glass. The liquidus viscosity is the viscosity of a glass at the liquidus temperature.

The term “CTE,” as used herein, refers to the coefficient of thermal expansion of the glass composition over a temperature range from about room temperature (RT) to about 300 °C. The linear coefficient of thermal expansion (CTE) over the temperature range 25-300 °C is expressed in terms of ×10⁻⁷/°C, and determined following ASTM standard E228.

Young's modulus values and shear modulus in terms of GPa, and Poisson's ratio were determined using a resonant ultrasonic spectroscopy technique of the general type set forth in ASTM E1875-00e1. The terms “Young's modulus” and “elastic modulus” may be interchangeable.

The fracture toughness may be measured using known methods in the art, for example, using a chevron notch, short bar, notched beam and the like, according to ASTM C1421-10, “Standard Test Methods for Determination of Fracture Toughness of Advanced Ceramics at Ambient Temperature.”

Glass obtained by adding CuO to phosphate glass has been employed as filter glass, but phosphate glass has drawbacks such as poor weatherability and a tendency to develop surface roughness and clouding when exposed to high temperature and high humidity for extended periods. Thus, near-infrared light-absorbing filter glass having a basic composition in the form of fluorophosphate glass and having good weatherability is developed as described herein.

The present disclosure provides glass compositions, products such as articles or devices comprising the same, and method for making the glass composition and the products. The glass compositions are copper-containing and high P₂O₅ fluorophasphate glasses. The glass compositions have desirable optical performance such as a red-shifted cutoff wavelength. The compositions can be used as NIR filter glass for cameras. In some embodiments, these glasses may be used in combination with a coating to improve weatherability. It is designed to be operated at different path lengths, for example, at short path length (about 200 micron).

The glass is used as an NIR filter and is placed directly in front of a camera detector or image sensor in a CCD camera. Such a glass must provide high visible transmittance and strong absorption of near-infrared (NIR) wavelengths. In addition, the glass filter must be resistant to corrosion in hot and/or humid environments. The NIR filter, which may comprise the glass disclosed herein, alone or in combination with a coating. Without any NIR filter, the image collected may exhibit a pink hue. When the NIR filer comprising the glass is used, the image is redder in color, as it is to the human eye as it is supposed to be.

The need for NIR attenuation arises because the detector sensitivity spans the UV, VIS, and NIR regimes. When images are collected in low-ambient light conditions in the presence of a heat source that emits NIR (e.g., a stove or campfire) or a material that radiates NIR (e.g., black fabric), the detector becomes saturated with these longer wavelengths. This causes the color saturation of the image to be poor. With an appropriately designed NIR filter, color saturation can be improved by reducing the relative amount of NIR wavelengths that reach the detector.

During the extensive research and development, the inventors used a set of criteria to develop and choose good glass compositions.

For the optical property requirements, a good near-infrared light-absorbing glass needs to exhibit good transmission, based on a thickness of 0.21 mm, in the spectral transmittance of wavelengths of 400 to 700 nm, i.e., a high visible transmittance. The glass needs to provide a wavelength, at which a 50 percent transmittance is exhibited, is 635 nm or longer. Such a wavelength (“635 nm/T50%”) is referred as a red-shifted cutoff wavelength. The glass provides a transmittance at a wavelength shorter than the cutoff wavelength is higher than 50 percent, and a transmittance at a wavelength longer than the cutoff wavelength is less than 50 percent. For example, the glass needs to provide a transmittance higher than 85% at wavelengths in a range of 425-465 nm, and a transmittance higher than 87% at wavelengths in a range of 466-560 nm. For another example, the glass needs to provide a transmittance lower than 10% at a wavelength of 1,200 nm, and a transmittance lower than 5% at wavelengths in a range of 750-800 nm. The low transmittance requirement is referred as “high NIR absorbance.”

Good weatherability is required to withstand long-term use. When weatherability is poor, fogging occurs on the surface of the glass and it cannot be employed in applications such as optical filters. Weatherability is tested by maintaining an optically polished glass sample at 85 °C and a relative humidity (RH) of 85% for 120 hours and up to 1,000 hours, and then measuring the transmittance of the glass. After the exposure to 85 °C/85% RH, the change in transmittance of the glass needs to be less than 1%.

It is extremely difficult to meet these challenging requirements. To achieve the high near-infrared (NIR) absorbance and red-shifted cutoff wavelength (635 nm/T50%), it is necessary to introduce >15 mol % Cu²⁺ in an optimized base glass. Silicates and aluminates cannot generally solubilize such high concentrations of copper oxide. Additionally, the Cu²⁺ absorbance in silicates, aluminates, and borates is too blue-shifted to achieve the targeted a 635 nm cutoff wavelength and maintain the low NIR transmittance

Phosphate glasses can be used to solubilize large concentrations of transition metal ions and can accommodate the >15 mol % Cu²⁺ required to achieve the desired NIR attenuation. In these glasses, P₂O₅ concentration directly influences the peak position of the Cu²⁺ absorbance and the durability. As a trend, the higher the P₂O₅ concentration, the more red-shifted the Cu²⁺ absorbance becomes. For glasses with “high” Cu²⁺ concentration (>15 mol %), they must contain at least 50 mol % P₂O₅ to achieve the targeted redshifted 635 nm cutoff wavelength. If the P₂O₅ concentration decreases below 50%, the Cu²⁺ absorbance is too blue shifted.

Like the peak position of the Cu²⁺ absorbance, the chemical durability, specifically weathering in 85 °C/85% RH, of these glasses, scales directly with P₂O₅ concentration. Glasses with “good durability” defined as <1% change in transmittance after 120-1000 hours in 85 °C/85% RH, must have P₂O₅ concentrations below 37 mol %. At P₂O₅ concentrations much higher than 37 mol %, the durability can be improved in a several ways, such as increasing the Al₂O₃ concentration or introducing Fe₂O₃. However, in Cu-doped glasses, the presence of alumina increases the Cu¹⁺ population, causing reduced visible transmittance, as do Fe³⁺ cations. Cu²⁺ is preferred for desired optical performance. Accordingly, at the highest alumina concentration such as between 3 and 6 mol % that enable them to meet the visible transmittance requirement, the P₂O₅ concentration must be maintained at or below 37 mol % to achieve the targeted weathering performance.

It has been also proposed that a durable coating can be applied to these glasses as a means of improving weatherability. The coating may be a cost lower than those employed to increase the NIR attenuation. Accordingly, in some embodiments, one objective of the present disclosure glass compositions having improved optical performance, even though they may not meet the desired weatherability requirements. So, a new family of silico-fluorophosphate that exhibit high visible transmittance, good NIR absorption, and the red-shifted cutoff wavelengths (T50% at or above 635 nm) as required, has been developed.

Described herein is a new series of high-P₂O₅ silico-fluorophosphate near-infrared absorbing ‘blue’ filter glasses that can achieve the targeted visible transmittance, NIR absorption, specifically <10% transmittance at 1,200 nm at a thickness of 0.21 mm, and exhibit cutoff wavelengths that are longer than their targeted T50% of 635 nm. In some embodiments, these glasses may not satisfy the weatherability requirement, and they can be used in combination of a suitable coating to meet the weatherability requirement. The coating may be anti-reflective (AR) coating, infrared (IR) coating, or a combination thereof.

In one aspect, the present disclosure provides a glass or a glass composition and an article comprising the same. In accordance with some embodiments, a glass or a glass composition provided herein comprises the ingredients in mole percent on an oxide basis and by a fluorine content as shown in Table 1.

TABLE 1
Compositional ranges of an exemplary composition

| | Min | Max |
|---|---|---|
| Component | (mol %) | (mol %) |
| P₂O₅ | 45 | 70 |
| SiO₂ | 2 | 30 |
| Al₂O₃ | 4 | 12 |
| Li₂O | 0 | 5.1 |
| K₂O | 0.2 | 10 |
| ZnO | 0 | 20 |
| SrO | 0 | 7.4 |
| CuO | 5 | 16 |
| Sb₂O₃ | 0 | 4 |
| CeO₂ | 0 | 2 |
| Total Fluorine (F) | 0 | 35 |
| Total RO (including ZnO) | 0 | 23.4 |
| Total R′₂O | 0.3 | 14.3 |

RO is selected from MgO, CaO, SrO, BaO, and ZnO, and R′₂O is selected from Li₂O, Na₂O, K₂O. In some embodiments, Al₂O₃, CuO, MgO, CaO, SrO, BaO, ZnO, Li₂O, Na₂O, and K₂O may be partially fluorinated, and the related oxide contents can be referred as oxide equivalents.

In some embodiments, the glass is substantially free of B, Na, Ba, and Cl. No related raw materials are added.

In some embodiments, P₂O₅ is in a suitable range. For example, P₂O₅ is in a range of from 45 to 70 by mole percent, in a range of from 46 to 70 by mole percent, in a range of from 47 to 70 by mole percent, in a range of from 47.5 to 69 by mole percent, in a range of from 48 to 69 by mole percent, in a range of from 49 to 69 by mole percent, in a range of from 50 to 69 by mole percent, in a range of from 51 to 69 by mole percent, in a range of from 52 to 69 by mole percent, in a range of from 50 to 68 by mole percent, in a range of from 51 to 68 by mole percent, in a range of from 52 to 68 by mole percent, or any other suitable range.

In some embodiments, SiO₂ is in a suitable range. For example, SiO₂ is in a range of from 2 to 30 by mole percent, in a range of from 3 to 30 by mole percent, in a range of from 4 to 30 by mole percent, in a range of from 4.5 to 29 by mole percent, in a range of from 4.5 to 28 by mole percent, in a range of from 4.5 to 27 by mole percent, in a range of from 4.5 to 26 by mole percent, in a range of from 4.5 to 25 by mole percent, in a range of from 4.75 to 28 by mole percent, in a range of from 4.75 to 27 by mole percent, in a range of from 4.75 to 26 by mole percent, in a range of from 4.75 to 25 by mole percent, or any other suitable range.

In some embodiments, Al₂O₃ is in a suitable range. For example, Al₂O₃ is in a range of from 4 to 12 by mole percent, in a range of from 3 to 11 by mole percent, in a range of from 3 to 10 by mole percent, in a range of from 4 to 8 by mole percent, in a range of from 4 to 7 by mole percent, in a range of from 4 to 6 by mole percent, in a range of from 3 to 6 by mole percent, in a range of from 2.5 to 5 by mole percent, in a range of from 3 to 5 by mole percent, in a range of from 3.5 to 4.5 by mole percent, or any other suitable range.

In some embodiments, CuO is in a suitable range. For example, CuO is in a range of from 5 to 16 by mole percent, in a range of from 6 to 16 by mole percent, in a range of from 6 to 15 by mole percent, in a range of from 6 to 14 by mole percent, in a range of from 7 to 16 by mole percent, in a range of from 7 to 15 by mole percent, in a range of from 7 to 14 by mole percent, or any other suitable range.

In some embodiments, RO is in a suitable range. For example, the combined concentration of RO is in a range of from 0 to 23.4 by mole percent, in a range of from 0 to 22 by mole percent, in a range of from 0 to 20 by mole percent, in a range of from 1 to 20 by mole percent, in a range of from 1.5 to 18 by mole percent, in a range of from 1.5 to 17 by mole percent, in a range of from 2 to 17 by mole percent, in a range of from 2 to 16 by mole percent, in a range of from 2 to 15 by mole percent, in a range of from 2 to 14 by mole percent, or any other suitable range.

In some embodiments, RO is selected from ZnO only or a combination of ZnO and SrO. The glass may be substantially free of BaO.

In some embodiments, ZnO is in a suitable range. For example, ZnO is in a range of from 0 to 20 by mole percent, in a range of from 0.25 to 20 by mole percent, in a range of from 0.5 to 18 by mole percent, in a range of from 0.5 to 17 by mole percent, in a range of from 0.75 to 16 by mole percent, in a range of from 0.75 to 15 by mole percent, in a range of from 0.75 to 14 by mole percent, or any other suitable ranges.

In some embodiments, SrO is in a suitable range. For example, SrO is in a range of from 0 to 7.4 by mole percent, in a range of from 0 to 7 by mole percent, in a range of from 0 to 6 by mole percent, in a range of from 0.25 to 7 by mole percent, in a range of from 0.25 to 6 by mole percent, in a range of from 0.5 to 6 by mole percent, in a range of from 0.5 to 5 by mole percent, in a range of from 0.75 to 5 by mole percent, in a range of from 0.75 to 4 by mole percent, or any other suitable ranges.

In some embodiments, R′₂O is in a suitable range. For example, the combined concentration of R′₂O is in a range of from 0.3 to 14.3 by mole percent, in a range of from 0.3 to 14 by mole percent, in a range of from 0.5 to 14 by mole percent, in a range of from 0.5 to 12 by mole percent, in a range of from 0.5 to 10 by mole percent, in a range of from 0.75 to 10 by mole percent, in a range of from 0.75 to 8 by mole percent, in a range of from 1 to 8 by mole percent, in a range of from 1 to 7 by mole percent, in a range of from 1 to 6 by mole percent, or any other suitable range.

The R₂O identity plays a role in chemical durability and optical transmittance of the resulting glass compositions. Li₂O is more favorable than K₂O, which is more favorable relative to Na₂O. In some embodiments, R′₂O is selected from Li₂O and K₂O, and the compositions are also substantially free of Na.

In some embodiments, Li₂O is in a suitable range. For example, Li₂O is in a range of from 1 to 5.1 by mole percent, in a range of from 0.1 to 5 by mole percent, in a range of from 0.2 to 5 by mole percent, in a range of from 0.2 to 4 by mole percent, in a range of from 0.3 to 4 by mole percent, in a range of from 0.3 to 3 by mole percent, or any other suitable range.

In some embodiments, K₂O is in a suitable range. For example, K₂O is in a range of from 0.2 to 10 by mole percent, in a range of from 0.2 to 8 by mole percent, in a range of from 0.2 to 6 by mole percent, in a range of from 0.2 to 5 by mole percent, in a range of from 0.3 to 5 by mole percent, in a range of from 0.4 to 5 by mole percent, in a range of from 0.4 to 4.5 by mole percent, in a range of from 0.5 to 5 by mole percent, in a range of from 0.6 to 4 by mole percent, or any other suitable range.

In some embodiments, the total fluorine is in a suitable range. For example, the total fluorine is in a range of from 0 to 35 by mole percent, in a range of from 1 to 32 by mole percent, in a range of from 2 to 30 by mole percent, in a range of from 3 to 29 by mole percent. in a range of from 4 to 28 by mole percent, in a range of from 5 to 27 by mole percent, in a range of from 6 to 26 by mole percent, in a range of from 6 to 25 by mole percent, in a range of from 10 to 25 by mole percent, in a range of from 10 to 22 by mole percent, in a range of from 10 to 20 by mole percent, or any other suitable range.

The total fluorine content (in mol %) is the molar sum of the fluorine from all fluorinated species in a glass composition. In the Examples described herein, the fluorine sources used include, but are not limited to, AlF₃, SrF₂, ZnF₂, LiF, KF, or a combination thereof. MgF₂, CaF₂, BaF₂ and NaF can be used if a composition is not free of Mg, Ca, Ba, or Na. These fluorides are also the sources of the corresponding oxides. The fluorine may be combined with Al, Mg, Ca, Sr, Ba, Cu, Zn, Li, Na, and K. Each corresponding oxide of Al, Mg, Ca, Sr, Ba, Cu, Zn, Li, Na, and K listed in the composition tables is referred as corresponding “oxide equivalent” or “equivalent of oxide,” which refers to the oxide basis to the maximum oxidation level based on the content of the corresponding metal selected from the group of Al, Mg, Ca, Sr, Ba, Cu, Zn, Li, Na, and K. For the oxide equivalents of Al, Mg, Ca, Sr, Ba, Cu, Zn, Li, Na, and K, the oxides may be partially replaced with fluorine. So, the corresponding oxide equivalent may include both the corresponding oxide and the corresponding fluoride of the same metal. In some embodiments, the fluorination may occur proportionally among these species. In some embodiments, the compositions are substantially free of Na, Ba, and Mg, no corresponding fluorides are used and the compositions are substantially free of related oxides.

No fluorination occurs to P₂O₅, SiO₂, and Sb₂O₃. The contents of P₂O₅, SiO₂, and Sb₂O₃ listed in Tables 1-4 and in the tables of examples are on oxide basis. Even if the term “oxide equivalent” is used with respect to P₂O₅, SiO₂, and Sb₂O₃, the content of the oxide equivalent is the same as the content of the corresponding oxide.

The content of “RO” or “R,” in the present disclosure refers to the sum of oxide equivalents of Mg, Ca, Sr, Ba, and Zn, wherein R is selected from Mg, Ca, Sr, Ba, and Zn. The content of total “R′₂O” refers to the sum of oxide equivalents of alkali metals, where R′ is selected from Li, Na, and K.

In some preferred embodiments, a glass or a glass composition provided herein comprises the ingredients in mole percent on an oxide basis (except fluorine) as shown in Table 2.

TABLE 2
Preferred Compositions in some embodiments

| | Min | Max |
|---|---|---|
| Component | (mol %) | (mol %) |
| P₂O₅ | 45 | 70 |
| SiO₂ | 4 | 30 |
| Al₂O₃ | 2.5 | 5.5 |
| Li₂O | 0.1 | 5 |
| K₂O | 0.2 | 5 |
| ZnO | 0.25 | 20 |
| SrO | 0.25 | 6 |
| CuO | 5 | 16 |
| Sb₂O₃ | 0 | 3 |
| CeO₂ | 0 | 2 |
| Total Fluorine (F) | 2 | 30 |
| Total RO (including ZnO) | 1 | 20 |
| Total R′₂O | 0.5 | 10 |

In some more preferred embodiments, a glass or a glass composition provided herein comprises the ingredients in mole percent on an oxide basis (except fluorine) as shown in Table 3.

TABLE 3
More preferred compositions in some embodiments

| | Min | Max |
|---|---|---|
| Component | (mol %) | (mol %) |
| P₂O₅ | 47.5 | 69 |
| SiO₂ | 4.5 | 28 |
| Al₂O₃ | 3 | 5 |
| Li₂O | 0.2 | 4 |
| K₂O | 0.4 | 4.5 |
| ZnO | 0.5 | 17 |
| SrO | 0.5 | 5 |
| CuO | 6 | 15 |
| Sb₂O₃ | 0.1 | 0.3 |
| CeO₂ | 0 | 1 |
| Total Fluorine (F) | 6 | 25 |
| Total RO (including ZnO) | 1.5 | 17 |
| Total R′₂O | 0.75 | 8 |

In some more preferred embodiments, a glass or a glass composition provided herein comprises the ingredients in mole percent on an oxide basis (except fluorine) as shown in Table 4.

TABLE 4
More preferred compositions in some embodiments

| | Min | Max |
|---|---|---|
| Component | (mol %) | (mol %) |
| P₂O₅ | 52 | 68 |
| SiO₂ | 4.75 | 25 |
| Al₂O₃ | 3.5 | 4.5 |
| Li₂O | 0.3 | 3 |
| K₂O | 0.6 | 4 |
| ZnO | 0.75 | 14 |
| SrO | 0.75 | 4 |
| CuO | 7 | 14 |
| Sb₂O₃ | 0 | 0.1 |
| CeO₂ | 0.3 | 0.9 |
| Total Fluorine (F) | 10 | 20 |
| Total RO (including ZnO) | 2 | 14 |
| Total R′₂O | 1 | 6 |

The ranges listed in Tables 1-4 should be understood to include any narrower numerical ranges within a specified range. For example, for the RO content, the range of 0-23.4% listed in Table 1 is not limited to 1-20% listed in Table 2, 1.5-17% listed in Table 3, and 2-14% listed in Table 4 only. The range of 0-23.4% includes, but is not limited to, 0-23%, 0-21%, 0-20%, 0-19%, 0-18%, 0-17%, 0-16%, 0-15%, 1-23%, 1-22%, 1-21%, 1-19%, 1-18%, 1-17%, 1-16%, 1-15%, 2-23%, 2-22%, 2-21%, 2-20%, 2-19%, 2-18%, 2-17%, 2-16%, 2-15%, and any other ranges within the range of 0-23.4%.

The compositions are substantially free of B, Na, Ba, and Cl in accordance with some embodiments. The compositions may also be substantially free of MgO.

Sb₂O₃ is used optionally as a fining agent, but other chemical fining agents could also be employed to obtain glass of sufficient quality. For example, exemplary glasses could employ any one or combinations of SnO₂, As₂O₃, CeO₂, Fe₂O₃, and halides as deliberate additions to facilitate fining, and any of these could be used in conjunction with the Sb₂O₃ chemical fining agent shown in the examples. In some embodiments, Sb₂O₃ may be replaced with tin oxide (e.g. SnO₂) or CeO₂.

Fe₂O₃ may be introduced to increase visible absorbance and improve durability in the range of 0.1 mol % to about 3 mol %. Titania may be used to increase Young's modulus of the glass at concentrations of 0.25 mol % to about 5 mol %.

In some embodiments, the glass is substantially free of Sb₂O₃, which can be replaced with CeO₂ or SnO₂.

The glass and glass composition described herein have good optical performance. For example, the glass has a red-shifted cutoff wavelength with at least 50% transmittance at a thickness of 0.21 mm being at least 635 nm or longer. At the thickness of 0.21 mm, the glass has a transmittance higher than 85% at wavelengths in a range of 425-465 nm, a transmittance higher than 87% at wavelengths in a range of 466-560 nm, a transmittance lower than 5% at wavelengths in a range of 750-800 nm, and a transmittance lower than 10% at a wavelength of 1,200 nm.

In another aspect, a method for producing the glass or the glass composition as described herein is provided. Such a method comprises at least one step of mixing and melting raw materials in mole percent on an oxide basis and by the fluorine content so as to provide the oxides as described. Such a method may further comprise making a sheet comprising the glass composition through a suitable process. Examples of the raw material as the source for the total fluorine include, but are not limited to, AlF₃, CaF₂, SrF₂, ZnF₂, LiF, KF, and any combination thereof.

In another aspect, the present disclosure provides an article comprising the glass or the glass composition described herein. For example, an optical filter such as NIR filter comprises the glass or the glass composition described here. The filter is used for camera applications.

In the present disclosure, the bulk glass having the compositions as descried can satisfy the challenging requirements. It is optionally to use an additional coating in combination with the glass compositions.

### Examples

The following examples are set forth below to illustrate the methods and results according to the disclosed subject matter. These examples are not intended to be inclusive of all embodiments of the subject matter disclosed herein, but rather to illustrate representative methods and results. These examples are not intended to exclude equivalents and variations of the present disclosure which are apparent to one skilled in the art.

Efforts have been made to ensure accuracy with respect to numbers (e.g., amounts, temperature, etc.) but some errors and deviations should be accounted for. Unless indicated otherwise, temperature is in °C or is at ambient temperature, and pressure is at or near atmospheric. The compositions themselves are given in mole percent on an oxide basis and have been normalized to 100%. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

The glass properties set forth in tables were determined in accordance with techniques conventional in the glass art. Thus, the linear coefficient of thermal expansion (CTE) over the temperature range 25-300 °C is expressed in terms of ×10⁻⁷/°C and the annealing point is expressed in terms of °C. These were determined from fiber elongation techniques (ASTM references E228-85 and C336, respectively). The density in terms of grams/cm³ was measured via the Archimedes method (ASTM C693). The melting temperature in terms of °C (defined as the temperature at which the glass melt demonstrates a viscosity of 200 poises) was calculated employing a Fulcher equation fit to high temperature viscosity data measured via rotating cylinders viscometry (ASTM C965-81).

The viscosity of the glass at high temperatures is measured in accordance with ASTM C965-96 (2012), titled “Standard Practice for Measuring Viscosity of Glass Above the Softening Point.” As used herein, the “Vogel-Fulcher-Tamman” (VFT) relation describes the temperature dependence of the viscosity and is represented by the following equation:

log η=A+B T−To

where η is viscosity. To determine VFT A, VFT B, and VFT Tₒ, the viscosity of the glass composition is measured over a given temperature range. The raw data of viscosity versus temperature is then fit with the VFT equation by least-squares fitting to obtain A, B, and T₀. With these values, a viscosity point (e.g., 200 Poise (P) Temperature, 35,000 P Temperature, and 200,000 P Temperature) at any temperature above softening point may be calculated.

The liquidus temperature of the glass in terms of °C was measured using the standard gradient boat liquidus method of ASTM C829-81. This involves placing crushed glass particles in a platinum boat, placing the boat in a furnace having a region of gradient temperatures, heating the boat in an appropriate temperature region for 24 hours, and determining by means of microscopic examination the highest temperature at which crystals appear in the interior of the glass. More particularly, the glass sample is removed from the Pt boat in one piece and examined using polarized light microscopy to identify the location and nature of crystals which have formed against the Pt and air interfaces, and in the interior of the sample. Because the gradient of the furnace is very well known, temperature vs. location can be well estimated, within 5-10 °C. The temperature at which crystals are observed in the internal portion of the sample is taken to represent the liquidus of the glass (for the corresponding test period). Testing is sometimes carried out at longer times (e.g. 72 hours), to observe slower growing phases. The liquidus viscosity in poises was determined from the liquidus temperature and the coefficients of the Fulcher equation.

Young's modulus values and shear modulus in terms of GPa, and Poisson's ratio were determined using a resonant ultrasonic spectroscopy technique of the general type set forth in ASTM E1875-00e1.

Described herein is a new series of high-P₂O₅ fluorophosphate near-infrared absorbing “blue” filter glasses that can achieve the targeted visible transmittance, NIR absorption, specifically <10% transmittance at 1,200 nm at a thickness of 0.21 mm and exhibit cutoff wavelengths that are longer than their targeted T50% of 635 nm. Also described is a method of making these glasses, which is important for achieving the customer's targeted optical attributes.

As described herein, these glasses require very specific ranges and ratios of species to deliver the targeted cutoff wavelength. These different ranges and ratios, as well as the process required to make these glasses, are described herein. Composition tables are for the as-batched material in mole percent (mol %).

### 1. Raw Materials, Processes, and Resulting Compositions

The exemplary glasses in the tables were prepared using a commercial sand as a silica source, milled such that 90% by weight passed through a standard U.S. 100 mesh sieve. Alumina and/or aluminum metaphosphate (Al(PO₃)₃) was used as the source for alumina.

Phosphorous pentoxide, phosphoric acid liquid, a phosphate salt, or a mixture thereof was used as a source for phosphorous pentoxide (P₂O₅). In the Examples described herein, the batching of P₂O₅ was achieved in combination by batching solid (powder form) phosphate-bearing compounds in combination with liquid phosphoric acid and/or anhydrous solid phosphorous pentoxide. Anhydrous P₂O₅ is very reactive and hygroscopic and leads to clumping and exothermic reactions with some of the other raw materials, notably the other hygroscopic compounds due to elevated concentration of H₂O in the batch. Liquid phosphoric acid is also very reactive and requires a calcining step prior to melting, which can lead to foaming and other complications. It was also found that by drying all raw materials prior to the introduction of liquid or anhydrous P₂O₅, strong exothermic reactions could be avoided.

Lithium metaphosphate was used as the source for lithium oxide (Li₂O). Potassium nitrate, potassium carbonate, potassium phosphate monobasic, or a mixture thereof was used as the source for potassium oxide (K₂O).

Monomagnesium phosphate (Mg(H₂PO₄)₂) was used for the source of magnesium oxide (MgO). Monocalcium phosphate anhydrous (Ca(H₂PO₄)₂), calcium carbonate, or a mixture thereof was used for the source of calcium oxide. Strontium oxide was used for the source for strontium oxide. Barium metaphosphate, barium dihydrogen phosphate, barium nitrate, or a mixture thereof was used as the source for BaO.

Zinc pyrophosphate (Zn₂P₂O₇), zinc oxide, or a mixture thereof was used as the source for ZnO.

Copper (II) phosphate, copper (II) metaphosphate, or a mixture thereof was used as the source for oxide of copper such as CuO.

The salts of phosphate, metaphosphate, and pyrophosphate are also additional sources for phosphorous pentoxide (P₂O₅).

Examples of suitable sources used for fluorine (or fluoride) include, but are not limited to, aluminum fluoride (AlF₃), strontium fluoride (SrF₂), zinc fluoride (ZnF₂), lithium fluoride (LiF), potassium fluoride (KF), or a combination thereof. These fluorides used may also provide the corresponding oxides. The fluorine may be combined with Al, Ca, Sr, Cu, Zn, Li, and K. Calcium fluoride (CaF₂), barium fluoride (BaF₂), and/or sodium fluoride (NaF) can be used if the compositions are not free of Ca, Ba, Na. Fluorination may be proportionally distributed among these species in some embodiments. No fluorine is combined with P₂O₅, SiO₂, and Sb₂O₃.

In the Examples described herein, the fluorine sources used include, but are not limited to, AlF₃, CaF₂, SrF₂, ZnF₂, LiF, KF, or a combination thereof. AlF₃, CaF₂, SrF₂, ZnF₂ are preferred. These fluorides also provide the corresponding oxides. In the tables showing the compositions of the Examples, the amount of one or more fluorides used are presented for the convenience of description. The one or more fluorides used should be considered as the sources for both corresponding oxides and fluorinated counterpart. For example, referring to Table 5, when SrF₂ and AlF₃ were used as the ingredient for fluorination, the amount listed for the fluorides in the tables of the Examples such as Table 5 was the actual amount of each fluoride used. The fluorine may be combined with Al, Ca, Sr, Cu, Zn, Li, and K. For the metals such as Al, Ca, Sr, and Zn in the fluorine source(s) used, the total amount of a corresponding oxide equivalent should include the amount of the metal fluoride used. For example, referring to Example 1, 5 mol. % of SrF₂ and 4 mol % of AlF₃ were used as the source of fluorine. The amount of the SrO equivalent is 4 mol. % and the amount of the Al₂O₃ equivalent is 4 mol. % while they may be partially fluorinated. For the oxide equivalents of Al, Ca, Sr, Ba, Cu, Zn, Li, Na, and K, the oxides may be partially replaced with fluorine.

Antimony (III) oxide was used the source for Sb₂O₃. Cerium (IV) oxide was used as the source for CeO₂.

Mixing of batch materials was conducted by turbula mixing, sometimes with media, and sometimes by ball milling for times ranging from 0.25-24 hours. To minimize changes in the oxidation state of copper, all melts were made in quartz crucibles that were fitted with lids to prevent volatilization of fluorine, phosphorous, and other species. Melts were made at temperatures between 800-1,300 °C for times ranging from 2-24 hours in ambient air electric ovens. Sometimes the atmosphere over the melt was controlled using a “cover gas” comprised of at least one of the following: nitrogen, argon, and/or oxygen. Melts were homogenized by mechanical stirring or agitation. Melts were cast onto steel and other metal tables, molds, and annealed at temperatures ranging from 325-600 °C. Glasses were also cast onto graphite plates and ramps to promote faster cooling.

Melts can be made in other crucible types such as alumina or platinum. Alumina uptake can decrease the Cu²⁺ population and is therefore not recommended for the melting of these filter glasses in some embodiments. The colder the melt is, the more copper remains in the 2+ oxidation state, which is favorable for this filter glass application requiring high visible transmittance. This has been confirmed by melting copper-rich phosphate glasses in a platinum crucible at three different temperatures, including 900 °C, 1,000 °C, and 1,100 °C for 4 hours of melting time. The color of the 900 °C melt was a bright cobalt blue, the color of the 1,000 °C melt was a teal color, and the color of the 1,100 °C melt was an emerald green. Without being bound by theory, this change in color (i.e., transmittance) is due to the decrease in the Cu²⁺/Cu¹⁺ ratio, which is governed by melting temperature.

The glasses of the tables herein may be prepared using standard methods well-known to those skilled in the art. Such methods include a continuous melting process, such as would be performed in a continuous melting process, wherein the melter used in the continuous melting process is heated by gas, by electric power, or combinations thereof.

In addition, raw materials appropriate for producing exemplary glasses include commercially available sands as sources for SiO₂; alumina, aluminum hydroxide, hydrated forms of alumina, and various aluminosilicates, nitrates and halides as sources for Al₂O₃; boric acid, anhydrous boric acid and boric oxide as sources for B₂O₃; periclase, dolomite (also a source of CaO), magnesia, magnesium carbonate, magnesium hydroxide, and various forms of magnesium silicates, aluminosilicates, nitrates and halides as sources for MgO; limestone, aragonite, dolomite (also a source of MgO), wolastonite, and various forms of calcium silicates, aluminosilicates, nitrates and halides as sources for CaO; and oxides, carbonates, nitrates and halides of strontium and barium. If a chemical fining agent is desired, tin can be added as SnO₂, as a mixed oxide with another major glass component (e.g., CaSnO₃), or in oxidizing conditions as SnO, tin oxalate, tin halide, or other compounds of tin known to those skilled in the art.

The glasses in the tables contain Sb₂O₃ as a fining agent, but other chemical fining agents could also be employed to obtain glass of sufficient quality. For example, exemplary glasses could employ any one or combinations of SnO₂, As₂O₃, CeO₂, Fe₂O₃, and halides as deliberate additions to facilitate fining, and any of these could be used in conjunction with the Sb₂O₃ chemical fining agent shown in the examples.

Tin oxide (e.g. SnO₂) may be substituted oxides of antimony as a fining agent and as a means to keep the copper oxidized to maximize the Cu²⁺ population in the glass, which is favorable for high visible transmittance and strong NIR absorbance. This would avoid the use of a regulated and environmentally undesirable specie.

Fe₂O₃ may be introduced to increase visible absorbance and improve durability in the range of 0.1 mol % to about 3 mol %. Titania may be used to increase Young's modulus of the glass at concentrations of 0.25 mol % to about 5 mol %. SnO₂—, Fe₂O₃—, and TiO₂-containing glasses were also made.

In addition to the elements deliberately incorporated into exemplary glasses, nearly all stable elements in the periodic table are present in glasses at some level, either through low levels of contamination in the raw materials, through high-temperature erosion of refractories and precious metals in the manufacturing process, or through deliberate introduction at low levels to fine tune the attributes of the final glass. For example, zirconium may be introduced as a contaminant via interaction with zirconium-rich refractories. As a further example, platinum and rhodium may be introduced via interactions with precious metals. As a further example, iron may be introduced as a tramp in raw materials, or deliberately added to enhance control of gaseous inclusions. As a further example, manganese may be introduced to control color or to enhance control of gaseous inclusions.

In the present disclosure, an example is also called a composition or a melt.

### 2. Exemplary Compositions and Results

Table 5 lists the compositions of Examples 1-9, which include three different concentrations of P₂O₅ and SiO₂ at a fixed CuO concentration.

TABLE 5
Compositions of Examples 1-9 in as-batched mole percent (mol %) and their optical properties

| | Example No. | | | | | | | | |
|---|---|---|---|---|---|---|---|---|---|
| Composition (mol %) | 1 | 2 | 3 | 4 | 5 | 6 | 7 | 8 | 9 |
| P₂O₅ | 45 | 45 | 45 | 55 | 55 | 55 | 65 | 65 | 65 |
| SiO₂ | 5 | 10 | 15 | 5 | 10 | 15 | 5 | 10 | 15 |
| Al₂O₃ | 0 | 0 | 0 | 0 | 0 | 0 | 0 | 0 | 0 |
| AlF₃ | 4 | 4 | 4 | 4 | 4 | 4 | 4 | 4 | 4 |
| Li₂O | 4 | 3.4 | 2.6 | 2 | 1.7 | 0.9 | 1 | 0.7 | 0.3 |
| K₂O | 10.3 | 9.1 | 7.5 | 7.3 | 6.4 | 4.7 | 3.3 | 1.7 | 1.1 |
| ZnO | 18.4 | 15.8 | 14.2 | 15.4 | 12.1 | 10.4 | 12.4 | 9.6 | 6 |
| SrO | 0 | 0 | 0 | 0 | 0 | 0 | 0 | 0 | 0 |
| SrF₂ | 5 | 4.4 | 3.4 | 3 | 2.5 | 1.7 | 1 | 0.7 | 0.3 |
| CuO | 8 | 8 | 8 | 8 | 8 | 8 | 8 | 8 | 8 |
| Sb₂O₃ | 0.3 | 0.3 | 0.3 | 0.3 | 0.3 | 0.3 | 0.3 | 0.3 | 0.3 |
| Total fluorine (F) | 22 | 20.8 | 18.8 | 18 | 17 | 15.4 | 14 | 13.4 | 12.6 |
| Total RO (Mg, Ca, Sr, | 23.40 | 20.20 | 17.60 | 18.40 | 14.60 | 12.10 | 13.40 | 10.30 | 6.30 |
| Ba, Zn) | | | | | | | | | |
| Total R′₂O (Li, Na, K) | 14.30 | 12.50 | 10.10 | 9.30 | 8.10 | 5.60 | 4.30 | 2.40 | 1.40 |
| Total | 100 | 100 | 100 | 100 | 100 | 100 | 100 | 100 | 100 |
| Max. transmittance | 520 | | | 510 | 510 | 510 | 510 | 510 | 510 |
| wavelength (nm) | | | | | | | | | |
| Max. visible | 88.1 | | | 90.2 | 89.1 | 89.9 | 90.1 | 89.9 | 89.8 |
| transmittance (%) | | | | | | | | | |
| T50% cutoff | 647.4 | | | 684.4 | 685.3 | 683.2 | 692.1 | 672.1 | 663.0 |
| wavelength (nm) | | | | | | | | | |
| Transmittance at 1200 | 27 | | | 27.6 | 26.8 | 22.6 | 18.9 | 13.6 | 13.2 |
| nm (%) | | | | | | | | | |

Examples 1-3, which include the lowest P₂O₅ concentration (45 mol %) show the greenest color, indicating they contain more Cu¹⁺ than those with the compositions having a higher P₂O₅ content (Examples 4-9). It is known that the ratio of Cu²⁺ to Cu¹⁺ increases with increasing P₂O₅ concentration. With increasing P₂O₅ concentration, the glass became more transparent and simultaneously more “teal blue” in color. Silica concentration also had a noticeable impact on color as well, which was especially noticeable when comparing Examples 7, 8, and 9, which comprises 5, 10, and 15 mol % of SiO₂, respectively. As the silica concentration increased the glasses shifted from a light “electric copper blue” color to a darker “ice blue” color.

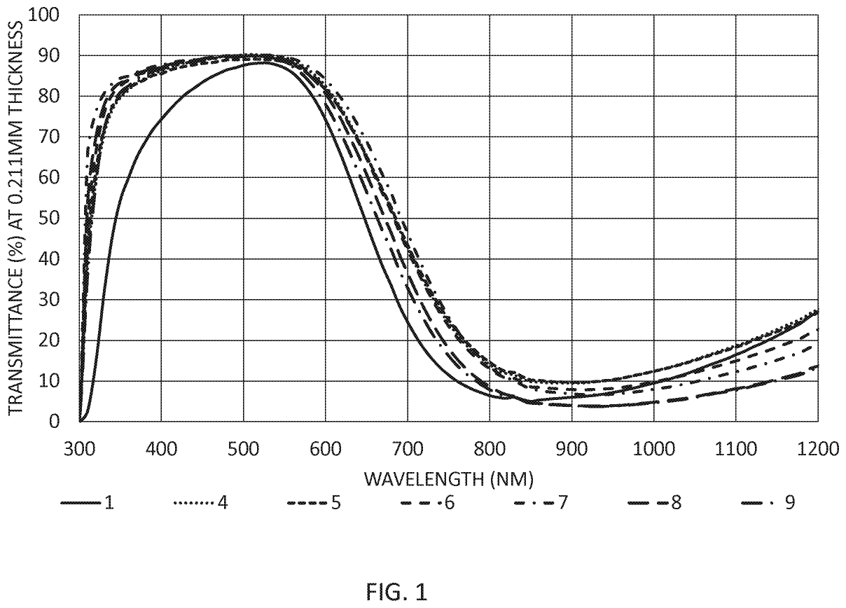

The optical transmittance spectra of Examples 1 and 4-9 are shown in FIG. 1 for samples polished to a thickness of 0.21 mm. Their optical properties such as the peak transmittance, the 50% cutoff wavelength, and the transmittance at 1,200 nm obtained from FIG. 1, are shown in Table 5 to enable a more facile comparison. As shown in Table 5, there are significant differences in the peak transmittance and the cutoff wavelength, which are predominately influenced by the concentration of P₂O₅ and SiO₂.

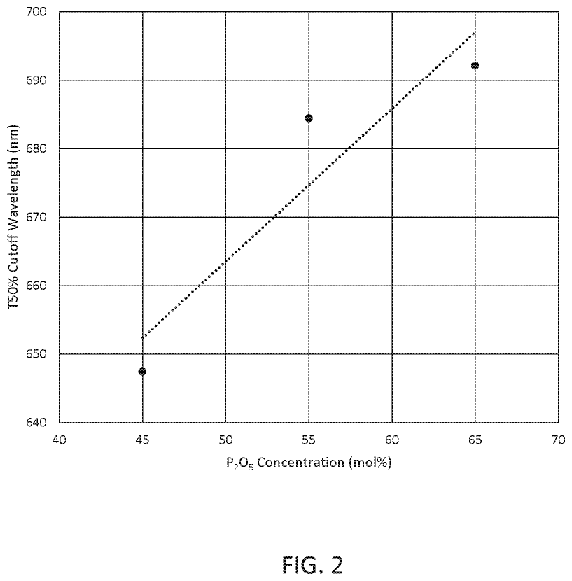

FIG. 2 shows the effect of P₂O₅ concentration on the cutoff wavelength of the glass based on the results of Examples 1, 4, and 7 having 45 mol %, 55, mol %, and 65 mol % P₂O₅, respectively, and fixed SiO₂ concentration (5 mol %) and CuO concentration (8 mol %).

As shown in FIG. 2, increasing P₂O₅ from 45 mol % to 65 mol % at fixed SiO₂ and CuO concentrations of 5 mol % and 8 mol %, respectively, results in a significant redshift in the cutoff wavelength. The peak position of the Cu²⁺ absorbance redshifts with increasing P₂O₅.

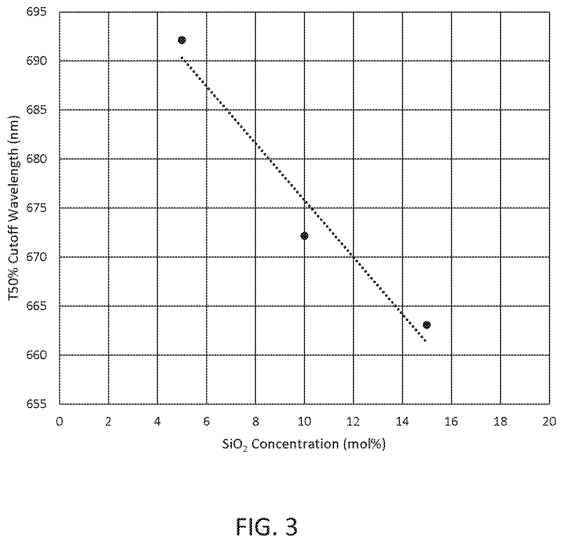

As noted, the SiO₂ concentration of the glass has a significant impact on optical properties. FIG. 3 shows the effect of SiO₂ concentration on the cutoff wavelength of the glass based on the results of Examples 7-9 including 5 mol %, 10, mol %, and 15 mol % SiO₂, respectively, and fixed P₂O₅ concentration (65 mol %) and CuO concentration (8 mol %). As shown in FIG. 3, as SiO₂ is increased from 5 to 15 mol % at fixed P₂O₅ and CuO concentrations of 65 mol % and 8 mol %, respectively, the cutoff wavelength blue shifts. As show in Table 5, this increase in silica is accompanied by a step change in the NIR transmittance at 1,200 nm. Example 7 has 10 mol % SiO₂ and shows a transmittance (%) at 1,200 nm (T1200 nm) of 18.9%. Examples 8 and 9 comprise 10 mol % and 15 mol % SiO₂, respectively, and both have T1200 nm values of between 13-14%. These trends in cutoff wavelength and NIR transmittance at 1,200 nm is generally consistent when P₂O₅ is at lower concentrations (e.g., 55 mol %).

The chemical durability of these high-P₂O₅ compositions (Examples 1-9) is not sufficient. After 24 hours at 85 °C/85% relative humidity (RH), the glass surfaces were corroded and frosty. However, the compositions having insufficient weatherability in the present disclosure can be used in combination with a weathering resistant coating thereon in the design of an optical filter.

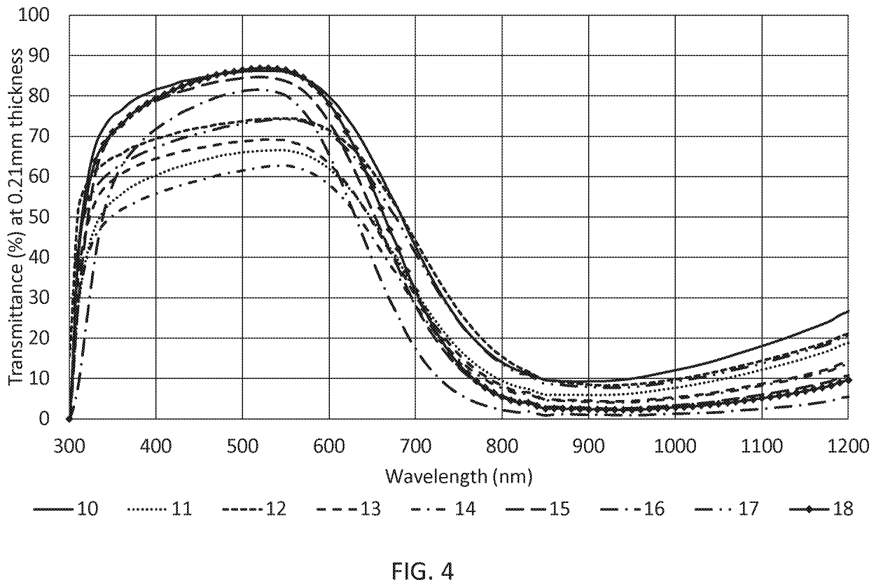

Additional examples (Examples 10-18) made with varying silica and phosphorous concentrations are shown in Table 6. These glasses have SiO₂ at 5 mol % and 10 mol % and P₂O₅ concentrations that range from 55-70 mol % at three different CuO concentrations 8, 10, and 12 mol %. The optical transmittance spectra of Examples 10-18 are shown in FIG. 4 for samples polished to a thickness of 0.21 mm. Table 6 also shows the optical properties obtained from the spectra, including the peak transmittance, the 50% cutoff wavelength, and the transmittance at 1,200 nm.

TABLE 6
Compositions of Examples 10-18 in as-batched mole percent (mol %) and their optical properties

| | Example No. | | | | | | | | |
|---|---|---|---|---|---|---|---|---|---|
| Composition (mol %) | 10 | 11 | 12 | 13 | 14 | 15 | 16 | 17 | 18 |
| P₂O₅ | 55 | 55 | 65 | 65 | 70 | 70 | 70 | 65 | 65 |
| SiO₂ | 5 | 10 | 5 | 10 | 5 | 10 | 15 | 5 | 5 |
| Al₂O₃ | 0 | 0 | 0 | 0 | 0 | 0 | 0 | 0 | 0 |
| AlF₃ | 4 | 4 | 4 | 4 | 4 | 4 | 4 | 4 | 4 |
| Li₂O | 2 | 1.7 | 1 | 0.7 | 0.7 | 0.7 | 0.3 | 1 | 1 |
| K₂O | 7.3 | 6.4 | 3.3 | 1.7 | 1.7 | 1.3 | 1 | 3.3 | 3.3 |
| ZnO | 15.4 | 12.1 | 12.4 | 9.6 | 9.6 | 5 | 1 | 10.7 | 8.7 |
| SrO | 0 | 0 | 0 | 0 | 0 | 0 | 0 | 0 | 0 |
| SrF₂ | 3 | 2.5 | 1 | 0.7 | 0.7 | 0.7 | 0.4 | 0.7 | 0.7 |
| CuO | 8 | 8 | 8 | 8 | 8 | 8 | 8 | 10 | 12 |
| Sb₂O₃ | 0.3 | 0.3 | 0.3 | 0.3 | 0.3 | 0.3 | 0.3 | 0.3 | 0.3 |
| Total fluorine | 18 | 17 | 14 | 13.4 | 13.4 | 13.4 | 12.8 | 13.4 | 13.4 |
| (F) | | | | | | | | | |
| Total RO (Mg, | 18.40 | 14.60 | 13.40 | 10.30 | 10.30 | 5.70 | 1.40 | 11.40 | 9.40 |
| Ca, Sr, Ba, Zn) | | | | | | | | | |
| Total R′₂O (Li, | 9.30 | 8.10 | 4.30 | 2.40 | 2.40 | 2.00 | 1.30 | 4.30 | 4.30 |
| Na, K) | | | | | | | | | |
| Total | 100 | 100 | 100 | 100 | 100 | 100 | 100 | 100 | 100 |
| Max. | 520.0 | 540.0 | 540.0 | 530.0 | 550.0 | 520.0 | 520.0 | 550.0 | 530.0 |
| transmittance | | | | | | | | | |
| wavelength (nm) | | | | | | | | | |
| Max. visible | 86.2 | 66.6 | 74.4 | 69.2 | 62.8 | 84.7 | 81.6 | 74.2 | 86.9 |
| transmittance | | | | | | | | | |
| (%) | | | | | | | | | |
| T50% cutoff | 683.9 | 647.7 | 684.5 | 646.7 | 633.7 | 653.2 | 630.5 | 676.7 | 664.2 |
| wavelength (nm) | | | | | | | | | |
| Transmittance at | 26.6 | 18.8 | 21.1 | 14.1 | 13.5 | 10.8 | 5.5 | 20.7 | 9.6 |
| 1200 nm (%) | | | | | | | | | |

As observed from Examples 1-9, Examples 10-12 also exhibited decreased transmittance and blue shifting of the cutoff wavelength with increasing SiO₂ concentration (Table 6). Examples 10 and 11 had identical P₂O₅ and CuO concentrations of 55 mol % and 8 mol %, respectively, but had different SiO₂ concentrations: 5 and 10 mol %, respectively. This increase in silica between Examples 10 and 11 resulted in a decrease in the maximum visible and NIR transmittances of 19.6% and 7.8%, respectively, and a blue shifting of the cutoff wavelength by 36.1 nm. Similarly, Examples 12 and 13 that had identical P₂O₅ and CuO concentrations of 65 mol % and 8 mol %, respectively, but had different SiO₂ concentrations: 5 and 10 mol %, respectively. This increase in silica between Examples 12 and 13 resulted in decreases in maximum visible and NIR transmittances of 5.2% and 7%, respectively, and a blue shifting of the cutoff wavelength by 37.8 nm.

Examples 14-16 have the highest P₂O₅ concentration (70 mol %) among the samples made. In these melts, SiO₂ concentration was varied from 5-15 mol %, respectively. Like the compositions described above, as the silica concentration increased, the transmittance at 1,200 nm decreased (from 13.5% to 10.8% down to 5.5%). There was not a clear trend in the cutoff wavelength for Examples 14-16, and the peak visible transmittance increased with increasing SiO₂ concentration from 62.8% to between 81-84.7%.

The effect of increasing Cu can be observed by comparing Examples 10, 17, and 18 that have 8, 10, and 12 mol % CuO, respectively at fixed P₂O₅ and SiO₂ concentrations. As shown in FIG. 4 and Table 6, as the CuO is increased, the NIR transmittance decreases. Because the visible transmittance did not change significantly as evidenced by comparing Examples 10 and 18 having the peak visible transmittances of 86.2% and 86.9%, respectively, the added CuO resides in the 2+ oxidation state that absorbs in the NIR. The visible transmittance of Example 17 that had 10 mol % was anomalously low relative to Examples 10 and 18 and is ascribed to poor sample quality.

Examples 10-18 also exhibited insufficient chemical durability and showed surface corrosion after 24-hour exposure in 85 °C/85%.

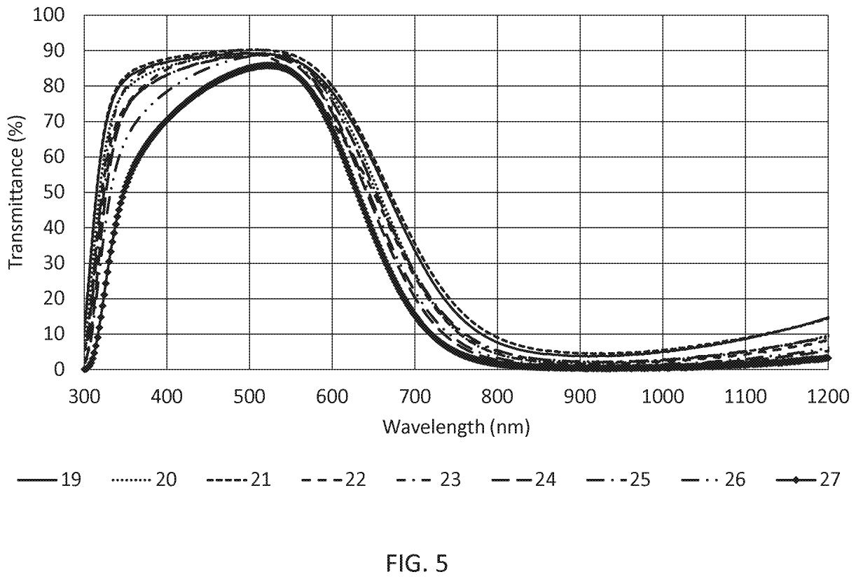

As shown in Table 7, additional composition, Examples 19-27, were made at “high” concentrations of SiO₂ that ranged from 15 mol % to 25 mol % at two different CuO concentrations (10 mol % and 12 mol) with P₂O₅ levels of 55 mol and 65 mol %, respectively. The optical transmittance spectra of Examples 19-27 are shown in FIG. 5 for samples polished to a thickness of 0.21 mm. Table 7 also shows the optical properties obtained from the spectra, including the peak transmittance, the 50% cutoff wavelength, and the transmittance at 1,200 nm.

TABLE 7
Compositions of Examples 19-27 in as-batched mole percent (mol %) and their optical properties

| | Example No. | | | | | | | | |
|---|---|---|---|---|---|---|---|---|---|
| Composition (mol %) | 19 | 20 | 21 | 22 | 23 | 24 | 25 | 26 | 27 |
| P₂O₅ | 55 | 55 | 55 | 55 | 55 | 55 | 65 | 65 | 65 |
| SiO₂ | 15 | 15 | 20 | 20 | 25 | 25 | 15 | 15 | 18.4 |
| Al₂O₃ | 0 | 0 | 0 | 0 | 0 | 0 | 0 | 0 | 0 |
| AlF₃ | 4 | 4 | 4 | 4 | 4 | 4 | 4 | 4 | 4 |
| Li₂O | 2 | 2 | 1 | 1 | 0.5 | 0.5 | 0.3 | 0.3 | 0 |
| K₂O | 3.7 | 3.7 | 2.7 | 2.7 | 0.8 | 0.8 | 0.6 | 0.6 | 0.3 |
| ZnO | 6.5 | 4.5 | 5 | 3 | 3.1 | 1.1 | 4.1 | 2.1 | 0 |
| SrO | 0 | 0 | 0 | 0 | 0 | 0 | 0 | 0 | 0 |
| SrF₂ | 3.5 | 3.5 | 2 | 2 | 1.3 | 1.3 | 0.7 | 0.7 | 0 |
| CuO | 10 | 12 | 10 | 12 | 10 | 12 | 10 | 12 | 12 |
| Sb₂O₃ | 0.3 | 0.3 | 0.3 | 0.3 | 0.3 | 0.3 | 0.3 | 0.3 | 0.3 |
| Total fluorine | 19 | 19 | 16 | 16 | 14.6 | 14.6 | 13.4 | 13.4 | 12 |
| (F) | | | | | | | | | |
| Total RO (Mg, | 10.00 | 8.00 | 7.00 | 5.00 | 4.40 | 2.40 | 4.80 | 2.80 | 0.00 |
| Ca, Sr, Ba, Zn) | | | | | | | | | |
| Total R′₂O (Li, | 5.70 | 5.70 | 3.70 | 3.70 | 1.30 | 1.30 | 0.90 | 0.90 | 0.30 |
| Na, K) | | | | | | | | | |
| Total | 100 | 100 | 100 | 100 | 100 | 100 | 100 | 100 | 100 |
| Max. | 502.0 | 510.0 | 508.0 | 488.0 | 508.0 | 514.0 | 514.0 | 520.0 | 522.0 |
| transmittance | | | | | | | | | |
| wavelength (nm) | | | | | | | | | |
| Max. visible | 89.2 | 89.3 | 90.3 | 89.5 | 90.2 | 88.8 | 89.2 | 88.8 | 85.8 |
| transmittance | | | | | | | | | |
| (%) | | | | | | | | | |
| T50% cutoff | 666.4 | 656.6 | 669.8 | 649.8 | 652.5 | 641.7 | 653.2 | 644.3 | 630.3 |
| wavelength (nm) | | | | | | | | | |
| Transmittance at | 14.7 | 9.7 | 14.4 | 8.4 | 9.3 | 5.2 | 9.4 | 5.9 | 3.3 |
| 1200 nm (%) | | | | | | | | | |

The results in Table 7 show a same trend as for the samples described above that increasing CuO decreases the NIR transmittance. Examples 19-27 show minimal changes in the peak visible transmittance because almost all of the copper remains in the 2+ oxidation state that absorbs in the NIR. For example, comparisons can be made between Examples 19 and 20 having 10 mol % and 12 mol % CuO, respectively. They exhibit the peak transmittance at 1,200 nm of 14.7% and 9.7% (a 5% difference), while their peak visible transmittance is almost identical (89.2% and 89.3%, respectively) as shown in Table 7.

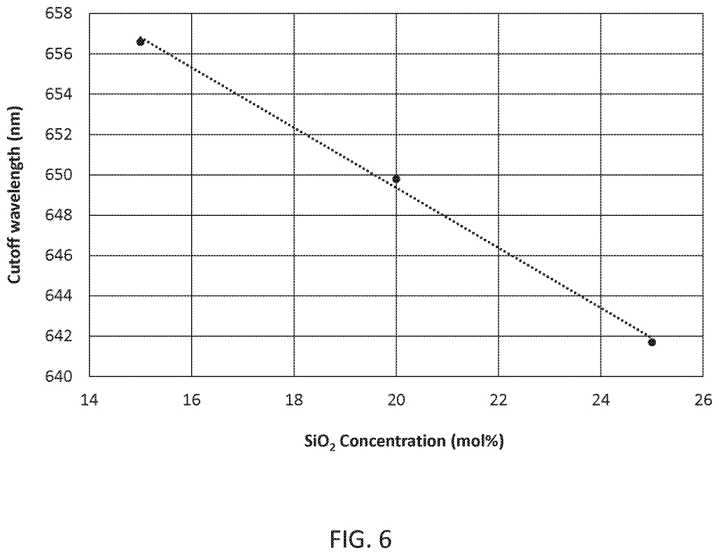

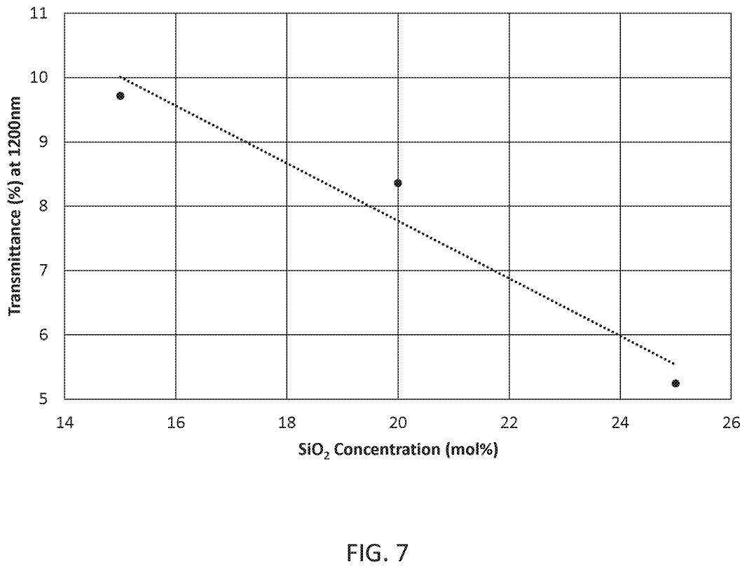

As shown in the samples described above, increasing silica from 15 mol % to 25 mol % at a fixed 55 mol % P₂O₅ concentration at either 10 or 12 mol % CuO blue-shifts the cutoff wavelength and decreases the NIR transmittance as shown in Table 7. This is graphically represented in FIGS. 6-7, by comparing compositions 20, 22, and 24 that contain 15, 20, and 25 mol % SiO₂ at fixed P₂O₅ and CuO concentrations of 55 mol % and 12 mol %, respectively. FIG. 6 and FIG. 7 show the cutoff wavelength and the transmittance at 1,200 nm, respectively, as a function of the SiO₂ concentration in Examples 20, 22, and 24. Examples 25 and 26 are direct analogs of Examples 19 and 20, respectively, but with 10 mol % higher P₂O₅, i.e., 65 mol % instead of 55 mol %. Interestingly, by comparing Example 19 to Example 25 and Example 20 to Example 26, it is observed that the increase in P₂O₅ concentration decreases the NIR absorption, for example, at 1,200 nm by about 4-5% and blue-shifts the cutoff wavelength by 12.3-13.2%. Therefore, depending on the optical requirements of an application, one can tune the cutoff wavelength and the NIR attenuation for a fixed CuO concentration by varying the concentrations and/or ratio of P₂O₅ and SiO₂.

Examples 19-27 also exhibit insufficient weathering performance. After 24-hour exposure at 85 °C/85% RH, these glasses exhibited hazy, corroded surfaces. As time progressed out to 120 hours, the sample appearance worsened. Their appearance was similar to other compositions tested including Examples 1-18.

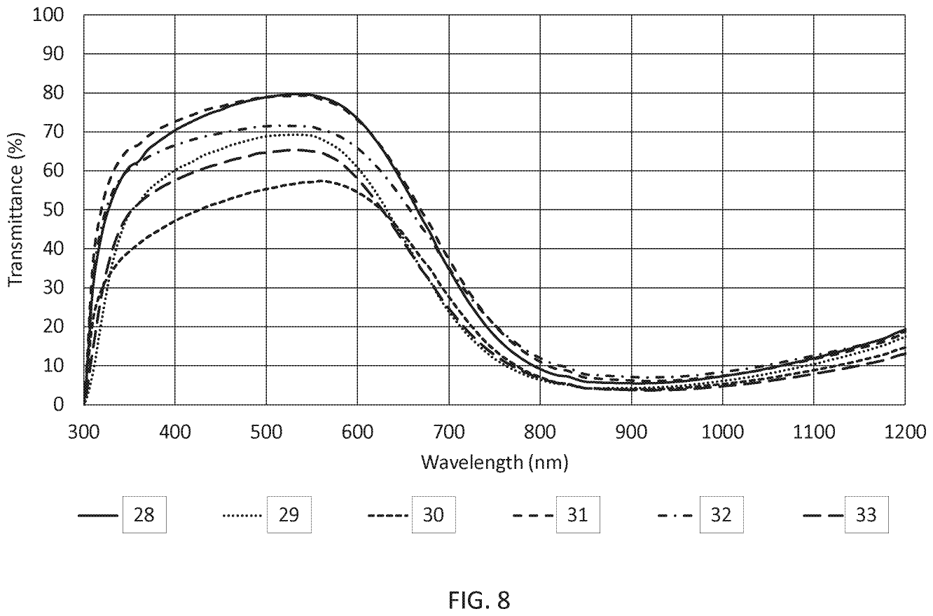

In attempts to improve the chemical durability, a series of compositions, Examples 28-33 as shown in Table 8, were made with fixed P₂O₅ and Cu concentrations of 60 mol % and 10 mol %, respectively at higher than regular alumina concentrations used. The optical transmittance spectra of Examples 28-33 are shown in FIG. 8 for samples polished to a thickness of 0.21 mm. Table 8 also shows the optical properties obtained from the spectra, including the peak transmittance, the 50% cutoff wavelength, and the transmittance at 1,200 nm.

TABLE 8
Compositions of Examples 28-33 in as-batched mole
percent (mol %) and their optical properties

| | Example No. | | | | | |
|---|---|---|---|---|---|---|
| Composition (mol %) | 28 | 29 | 30 | 31 | 32 | 33 |
| P₂O₅ | 60 | 60 | 60 | 60 | 60 | 60 |
| SiO₂ | 0 | 0 | 0 | 10 | 10 | 10 |
| Al₂O₃ | 6 | 8 | 12 | 6 | 8 | 12 |
| AlF₃ | 0 | 0 | 0 | 0 | 0 | 0 |
| Li₂O | 3.4 | 3 | 1.9 | 1.5 | 1 | 1 |
| K₂P | 6.3 | 5.3 | 3.8 | 2.8 | 2.5 | 1.7 |
| ZnO | 9 | 8.4 | 7 | 4.4 | 3.2 | 2 |
| SrO | 5 | 5 | 5 | 5 | 5 | 3 |
| SrF₂ | 0 | 0 | 0 | 0 | 0 | 0 |
| CuO | 10 | 10 | 10 | 10 | 10 | 10 |
| Sb₂P₃ | 0.3 | 0.3 | 0.3 | 0.3 | 0.3 | 0.3 |
| Total fluorine (F) | 0 | 0 | 0 | 0 | 0 | 0 |
| Total RO (Mg, Ca, Sr, | 14.00 | 13.40 | 12.00 | 9.40 | 8.20 | 5.00 |
| Ba, Zn) | | | | | | |
| Total R′₂O (Li, Na, K) | 9.70 | 8.30 | 5.70 | 4.30 | 3.50 | 2.70 |
| Total | 100 | 100 | 100 | 100 | 100 | 100 |
| Max. transmittance | 530.0 | 530.0 | 560.0 | 540.0 | 510.0 | 530.0 |
| wavelength (nm) | | | | | | |
| Max. visible | 79.7 | 69.2 | 57.4 | 79.3 | 71.6 | 65.3 |
| transmittance (%) | | | | | | |
| T50% cutoff | 665.4 | 631.9 | 625.9 | 669.1 | 657.3 | 626.8 |
| wavelength (nm) | | | | | | |
| Transmittance at 1200 | 19.3 | 17.4 | 14.7 | 18.2 | 18.8 | 13.1 |
| nm (%) | | | | | | |

The alumina concentration increases the network polymerization and in-turn increase chemical durability. To understand the degree to which silica influence weathering performance, Examples 28-30 are SiO₂-free and Examples 31-33 include 10 mol⁰% SiO₂. The alumina concentration was varied in these compositions from 8-12 mol %. This is much higher than an alumina concentration, about 4 mol %, used for the majority of the other compositions. The optical transmittance spectra of Examples 19-27 are shown in FIG. 8 for samples polished to a thickness of 0.21 mm, and the results of optical properties are shown in Table 8.

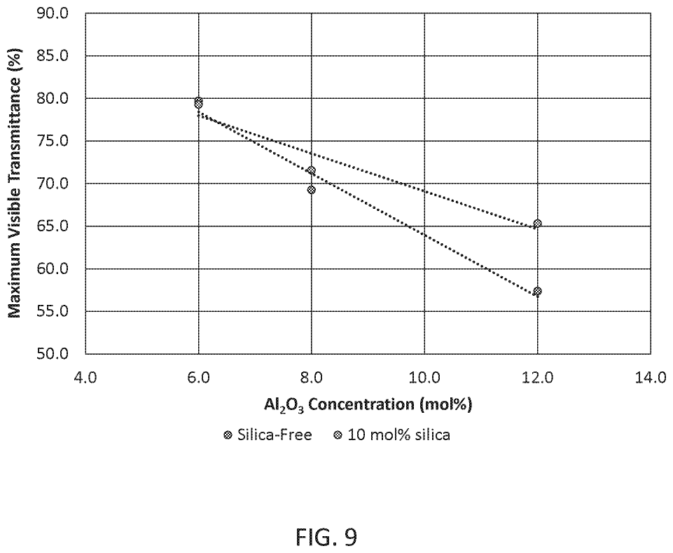

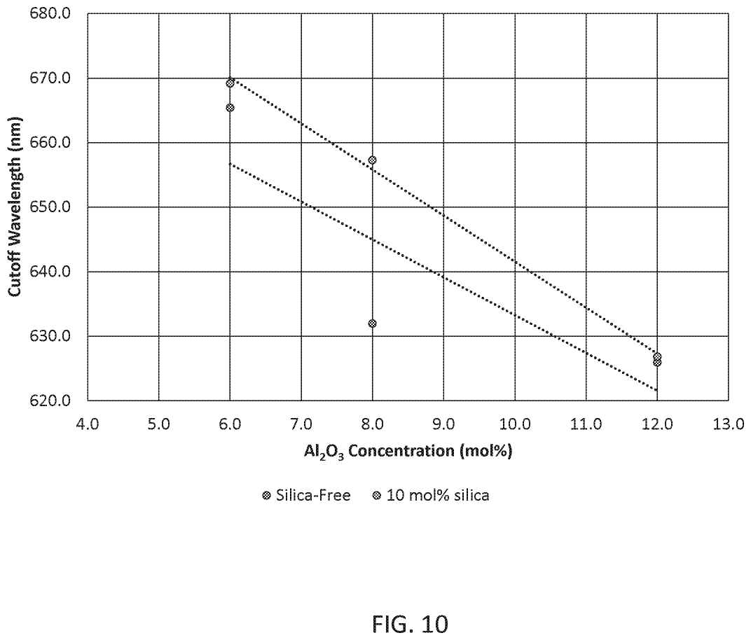

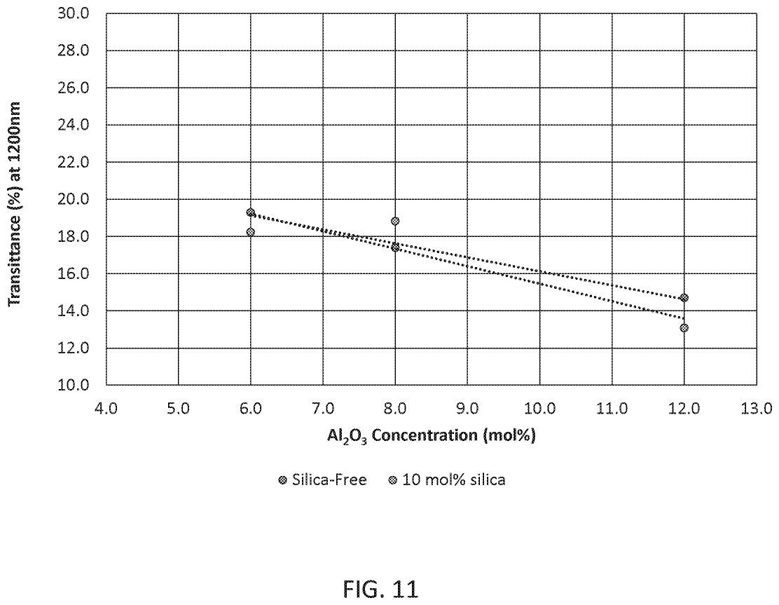

Irrespective of whether the glass contained silica or not, the compositions that had alumina concentrations >4 mol % (i.e., Examples 28-33) had lower transmittance across the UV and visible regimes. Without being bound by theory, this is due to a lower ratio of Cu²⁺ to Cu¹⁺ cations, which is heavily influenced by the total alumina concentration and the ratio of alumina to total modifier (R₂O+RO). The increased Cu¹⁺ population decreases UV and visible transmittance. This trend in decreased UV/VIS transmittance is accompanied by a blue-shifting of the cutoff wavelength and decrease in NIR transmittance. These trends are shown in FIGS. 9-11. FIGS. 9-11 show the maximum visible transmittance (FIG. 9), the cutoff wavelength, and the transmittance at 1,200 nm as a function of Al₂O₃ concentration in silica-free glasses (Examples 28-30) and silica containing glasses (Examples 31-33).

It was also observed that the durability of Examples 28-34 showed no improvement with increased alumina concentration after 120-hour exposure at 85 °C/85% RH. Nor did the presence or removal of silica from these compositions appear to have a significant impact on the weathering performance. However, it appeared that the compositions without silica (Examples 28-30) corroded more slowly than those with 10 mol % silica (Examples 31-33).

Additional compositions made, Examples 34-39, are shown in Table 9. These glasses have similar P₂O₅, SiO₂, and CuO concentrations as those described above. In Examples 34-37, the impact of different modifier identities including RO and R′₂O was evaluated. Example 34 is predominately ZnO-bearing. Example 35 is enriched in Li₂O. Example 36 has an even higher ZnO concentration than Example 34, and Example 37 is enriched in SrO. Examples 38 and 39 are slightly enriched in Al₂O₃.

The peak position of the Cu²⁺ absorbance can be red- or blue-shifted depending on the total modifier concentration and identity. However, it is also expected that because these glasses are predominately comprised of P₂O₅, SiO₂, and CuO, the influence of the modifiers on the optical properties of the compositions described herein (e.g., with at least 45 mol % of P₂O₅) is lower than that in the compositions having P₂O₅ lower than 45%.

TABLE 9
Compositions of Examples 34-39 in as-batched mole percent (mol %)

| | Example No. | | | | | |
|---|---|---|---|---|---|---|
| Composition (mol %) | 34 | 35 | 36 | 37 | 38 | 39 |
| P₂O₅ | 64 | 64 | 64 | 64 | 64 | 64 |
| SiO₂ | 14 | 14 | 14 | 14 | 13 | 12 |
| Al₂O₃ | 0 | 0 | 0 | 0 | 1 | 2 |
| AlF₃ | 4 | 4 | 4 | 4 | 4 | 4 |
| Li₂O | 0.3 | 5.1 | 0 | 0 | 0.3 | 0.3 |
| K₂O | 1.1 | 0.3 | 0.3 | 0.3 | 1.1 | 1.1 |
| ZnO | 6 | 2 | 7.4 | 0 | 6 | 6 |
| SrO | 0.3 | 0.3 | 0 | 7.4 | 0.3 | 0.3 |
| SrF₂ | 0 | 0 | 0 | 0 | 0 | 0 |
| CuO | 10 | 10 | 10 | 10 | 10 | 10 |
| Sb₂O₃ | 0.3 | 0.3 | 0.3 | 0.3 | 0.3 | 0.3 |
| Total fluorine (F) | 12 | 12 | 12 | 12 | 12 | 12 |
| Total RO (Mg, Ca, Sr, Ba, Zn) | 6.30 | 2.30 | 7.40 | 7.40 | 6.30 | 6.30 |
| Total R′₂O (Li, Na, K) | 1.40 | 5.40 | 0.30 | 0.30 | 1.40 | 1.40 |
| Total | 100 | 100 | 100 | 100 | 100 | 100 |

Some applications require a low Sb₂O₃ content, for example, <1000 ppm or <700 ppm, and even Sb₂O₃-free compositions. Therefore, a series of glasses, Examples 40-45, were modified based on Example 20, which has 0.3 mol % of Sb₂O₃(Table 7). The compositions of Examples 40-45 are shown in Table 10. Examples 40-45 have less or no Sb₂O₃.

TABLE 10
Compositions of Examples 40-45 in as-batched mole percent (mol %)

| | Example No. | | | | | |
|---|---|---|---|---|---|---|
| Composition (mol %) | 40 | 41 | 42 | 43 | 44 | 45 |
| P₂O₅ | 55 | 55 | 55 | 55 | 55 | 55 |
| SiO₂ | 15.273 | 15.273 | 15.28 | 15.28 | 15.29 | 15.3 |
| AlF₃ | 4 | 4 | 4 | 4 | 4 | 4 |
| Li₂O | 2 | 2 | 2 | 2 | 2 | 2 |
| K₂O | 3.7 | 3.7 | 3.7 | 3.7 | 3.7 | 3.7 |
| ZnO | 4.5 | 4.5 | 4.5 | 4.5 | 4.5 | 4.5 |
| SrF₂ | 3.5 | 3.5 | 3.5 | 3.5 | 3.5 | 3.5 |
| CuO | 12 | 12 | 12 | 12 | 12 | 12 |
| Sb₂O₃ | 0.027 | 0.027 | 0.02 | 0.02 | 0.01 | 0 |
| Total fluorine (F) | 19 | 19 | 19 | 19 | 19 | 19 |
| Total RO (Mg, Ca, Sr, | 8.00 | 8.00 | 8.00 | 8.00 | 8.00 | 8.00 |
| Ba, Zn) | | | | | | |
| Total R′₂O (Li, Na, K) | 5.70 | 5.70 | 5.70 | 5.70 | 5.70 | 5.70 |
| Total | 100 | 100 | 100 | 100 | 100 | 100 |

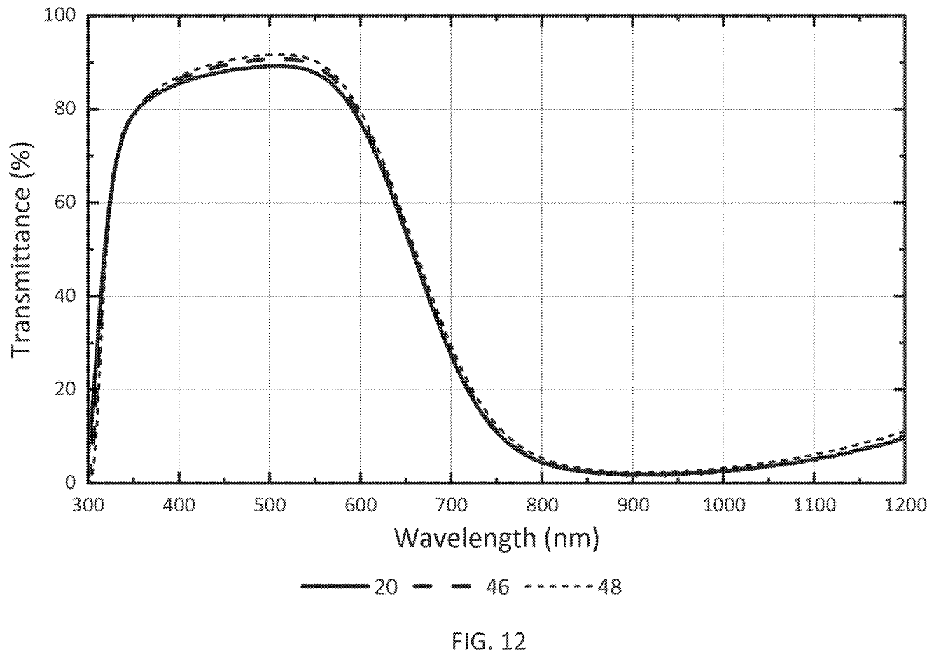

FIG. 12 shows the transmission spectra of Examples 40 and 50 compared to Example 20. Table 11 compares the optical properties of Examples 20, 40 and 45.

TABLE 11
Optical performance data of Examples
40 and 45 compared to Example 20

| | Examples | | |
|---|---|---|---|
| Properties | 20 | 40 | 45 |
| Lambda Tmax (nm) | 510 | 514 | 510 |
| Tmax (%) | 89.29 | 90.56 | 90.20 |
| NIR T50 (nm) | 656.60 | 659.12 | 661.63 |
| T1200 (%) | 9.72 | 10.23 | 11.48 |

The results in FIG. 12 and Table 11 show that Sb₂O₃ is not required in these compositions to achieve the desired optical properties. With decreasing Sb₂O₃, an increase in the maximum transmittance (Tmax), a red-shifted cutoff wavelength (NIR T50), and a slight increase in T1200, were observed.

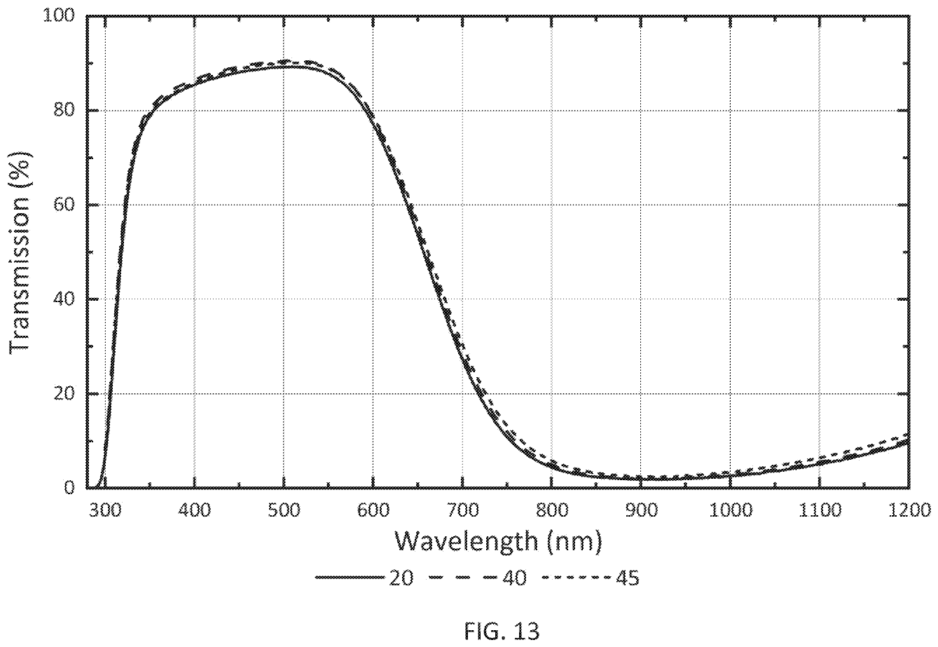

The effects of CeO₂ in both low Sb₂O₃ and Sb₂O₃-free glasses were further investigated. Table 12 shows the compositions of Example 46-47, which are free of Sb₂O₃ but include CeO₂. FIG. 13 shows the transmission spectra of Examples 46 and 48 compared to Example 20. Table 13 compares the optical properties of Examples 20, 46 and 48.

TABLE 12
Compositions of Example 46-47

| | Example No. | | | | | |
|---|---|---|---|---|---|---|
| Composition (mol %) | 46 | 47 | 48 | 49 | 50 | 51 |
| P₂O₅ | 55 | 55 | 55 | 55 | 55 | 55 |
| SiO₂ | 15 | 14.7 | 14.4 | 15 | 15 | 15 |
| AlF₃ | 4 | 4 | 4 | 4 | 4 | 4 |
| Li₂O | 2 | 2 | 2 | 2 | 2 | 2 |
| K₂O | 3.7 | 3.7 | 3.7 | 3.7 | 3.7 | 3.7 |
| ZnO | 4.5 | 4.5 | 4.5 | 4.5 | 4.5 | 4.5 |
| SrF₂ | 3.5 | 3.5 | 3.5 | 3.5 | 3.5 | 3.5 |
| CuO | 12 | 12 | 12 | 12 | 12 | 12 |
| CeO₂ | 0.3 | 0.6 | 0.9 | 0.3 | 0.3 | 0.3 |
| Total fluorine (F) | 13 | 13 | 13 | 13 | 13 | 13 |
| Total RO (Mg, Ca, Sr, Ba, | 8.00 | 8.00 | 8.00 | 8.00 | 8.00 | 8.00 |
| Zn) | | | | | | |
| Total R′₂O (Li, Na, K) | 5.70 | 5.70 | 5.70 | 5.70 | 5.70 | 5.70 |
| Total | 100 | 100 | 100 | 100 | 100 | 100 |

TABLE 13
Optical performance data of Examples
40 and 45 compared to Example 20

| | Examples | | |
|---|---|---|---|
| Properties | 20 | 46 | 48 |
| Lambda Tmax (nm) | 510 | 508 | 508 |
| Tmax (%) | 89.29 | 90.82 | 91.74 |
| NIR T50 (nm) | 656.60 | 657.35 | 660.29 |
| T1200 (%) | 9.72 | 9.67 | 11.11 |

As shown in FIG. 13 and Table 13, CeO₂ can be added in small amounts to increase the maximum transmittance (Tmax) and red-shift the cutoff wavelength (NIR T50). These compositions offer more desirable optical properties.

The compositions can be also characterized by weight percent. For example, in the Examples, SiO₂ was generally in a range of 2-13 wt. %, mostly in a range of from 2-8 wt. %. Al₂O₃ was generally in a range of from 3-10 wt. %, mostly in a range of 3-6 wt %. To the purpose of conciseness, the compositions in weight percent are not shown herein.

In addition to the above components, the glass compositions described herein can include various other oxides to adjust various physical, melting, fining, and forming attributes of the glasses. Examples of such other oxides include, but are not limited to, TiO₂, ZrO₂, HfO₂, Nb₂O₅, Ta₂O₅, MoO₃, WO₃, In₂O₃, Ga₂O₃, Bi₂O₃, GeO₂, PbO, SeO₃, TeO₂, Y₂O₃, La₂O₃, Gd₂O₃, and others known to those skilled in the art. In some embodiments, these oxides are not added. In some embodiments, the amount of each of these oxides can be less than or equal to 0.5 mole percent such as less than 0.1 mole percent including zero percent, and their total combined concentration can be less than or equal to 2.0 mole percent such as less than 1.0 mole percent. In some embodiments, the total combination concentration of these oxides is in a tamp amount, for example, less than 0.1 mole percent.

The glass compositions described herein can also include various contaminants associated with batch materials and/or introduced into the glass by the melting, fining, and/or forming equipment used to produce the glass, particularly Fe₂O₃ and ZrO₂. The glasses can also contain SnO₂ either as a result of Joule melting using tin-oxide electrodes and/or through the batching of tin containing materials, e.g., SnO₂, SnO, SnCO₃, and SnC₂O₂. In some embodiments, the glass is substantially free or free of Fe₂O₃, TiO₂, and ZrO₂

Hydrogen is inevitably present in the form of the hydroxyl anion, OH—, and its presence can be ascertained via standard infrared spectroscopy techniques. Dissolved hydroxyl ions significantly and nonlinearly impact the annealing point of exemplary glasses, and thus to obtain the desired annealing point it may be necessary to adjust the concentrations of major oxide components so as to compensate. Hydroxyl ion concentration can be controlled to some extent through choice of raw materials or choice of melting system. For example, boric acid is a major source of hydroxyls, and replacing boric acid with boric oxide can be a useful means to control hydroxyl concentration in the final glass. The same reasoning applies to other potential raw materials comprising hydroxyl ions, hydrates, or compounds comprising physisorbed or chemisorbed water molecules. If burners are used in the melting process, then hydroxyl ions can also be introduced through the combustion products from combustion of natural gas and related hydrocarbons, and thus it may be desirable to shift the energy used in melting from burners to electrodes to compensate. Alternatively, one might instead employ an iterative process of adjusting major oxide components so as to compensate for the deleterious impact of dissolved hydroxyl ions.

In addition to the major oxide components of exemplary glasses, and the minor or tramp constituents noted above, halides may be present at various levels, either as contaminants introduced through the choice of raw materials, or as deliberate components used to eliminate gaseous inclusions in the glass. As a fining agent, halides may be incorporated at a level of about 0.4 mol % or less, though it is generally desirable to use a lower amount if possible, to avoid corrosion of off-gas handling equipment. In some embodiments, the concentrations of individual halide elements are below about 200 ppm by weight for each individual halide, or below about 800 ppm by weight for the sum of all halide elements. As described above, the glass compositions are substantially free of chlorine.

The glass and the compositions provided in the present disclosure have significant advantages. For example, the glass compositions exhibit desirable physical properties, optical performance, and durability. The glass compositions are suitable for use as NIR filer.

In another aspect, the present disclosure provides an article comprising the glass or the glass composition described herein. For example, a filer comprises the glass or the glass composition described here.

As described above, the present disclosure provides novel near-infrared absorbing filter glass compositions with a red-shifted cutoff wavelength. These glasses are designed to operate at short path lengths (≈200 μm). The glasses, alone or in combination with a coating, can be used as a blue glass filter. The blue glass filters have a market greater than several hundred million dollars per year. The estimated market for the blue filter glass without coating is at least $50 million. Therefore, the products provided in the present disclosure have a significant potential in the blue glass filter market.

In another aspect, the present disclosure provides a device comprising the glass or glass composition as described herein.

In another aspect, a method for producing the glass or the glass composition as described herein is provided. Such a method comprises at least one step of mixing and melting raw materials in mole percent on an oxide basis so as to provide the oxides as described. Such a method may further comprise making a sheet comprising the glass composition.

Although the subject matter has been described in terms of exemplary embodiments, it is not limited thereto. Rather, the appended claims should be construed broadly, to include other variants and embodiments, which may be made by those skilled in the art.

What is claimed is:

1. A glass comprising in mole percent on an oxide basis and by a fluorine content:
P₂O₅: 45-70;
SiO₂: 2-30;
Al₂O₃: 4-12;
Li₂O: 0-5.1;
K₂O: 0.2-10;
ZnO: 0-20;
SrO: 0-7.4;
CuO: 5-16;
Sb₂O₃: 0-4;
CeO₂: 0-2;
total fluorine (F): 0-35;
wherein
a combined concentration of RO is in a range from 0 to 23.4,
a combined concentration of R′₂O is in a range of from 0.3 to 14.3,
RO is selected from the group consisting of MgO, CaO, SrO, BaO, and ZnO, and
R′₂O is selected from the group consisting of Li₂O, Na₂O, and K₂O.

2. The glass of claim 1, wherein one or more of Al₂O₃, CuO, MgO, CaO, SrO, BaO, ZnO, Li₂O, Na₂O, and K₂O are partially fluorinated.

3. The glass of claim 1, wherein the glass is substantially free of B, Na, Ba, and Cl.

4. The glass of claim 1, wherein P₂O₅ is in a range of from 45 to 70 by mole percent.

5. The glass of claim 1, wherein P₂O₅ is in a range of from 47.5 to 69 by mole percent.

6. The glass of claim 1, wherein P₂O₅ is in a range of from 52 to 68 by mole percent.

7. The glass of claim 1, wherein SiO₂ is in a range of from 4 to 30 by mole percent.

8. The glass of claim 1, wherein SiO₂ is in a range of from 4.5 to 28 by mole percent.

9. The glass of claim 1, wherein SiO₂ is in a range of from 4.75 to 25 by mole percent.

10. The glass of claim 1, wherein Al₂O₃ is in a range of from 2.5 to 5.5 by mole percent.

11. The glass of claim 1, wherein Al₂O₃ is in a range of from 3.5 to 4.5 by mole percent.

12. The glass of claim 1, wherein CuO is in a range of from 5 to 16 by mole percent.

13. The glass of claim 1, wherein CuO is in a range of from 7 to 14 by mole percent.

14. The glass of claim 1, wherein the total fluorine is in a range of from 2 to 30 by mole percent.

15. The glass of claim 1, wherein the total fluorine is in a range of from 10 to 20 by mole percent.

16. The glass of claim 1, wherein the combined concentration of RO is in a range of from 1 to 20 by mole percent.

17. The glass of claim 1, wherein the combined concentration of RO is in a range of from 2 to 14 by mole percent.

18. The glass of claim 1, wherein the combined concentration of R′₂O is in a range of from 0.5 to 10 by mole percent.

19. The glass of claim 1, wherein the combined concentration of R′₂O is in a range of from 1 to 6 by mole percent.

20. The glass of claim 1, wherein the glass comprises in mole percent on the oxide basis and the fluorine content:
P₂O₅: 45-70;
SiO₂: 4-30;
Al₂O₃: 2.5-5.5;
Li₂O: 0.1-5;
K₂O: 0.2-5;
ZnO: 0.25-20;
SrO: 0.25-6;
CuO: 5-16;
Sb₂O₃: 0-3;
CeO₂: 0-2;
total fluorine (F): 2-30;
wherein
a combined concentration of RO is in a range from 1 to 20, and
a combined concentration of R′₂O is in a range of from 0.5 to 10.

21. The glass of claim 1, wherein the glass comprises in mole percent on the oxide basis and the fluorine content:
P₂O₅: 47.5-69;
SiO₂: 4-28;
Al₂O₃: 3-5;
Li₂O: 0.2-4;
K₂O: 0.4-4.5;
ZnO: 0.5-17;
SrO: 0.5-5;
CuO: 6-15;
Sb₂O₃: 0.1-0.3;
CeO₂: 0-1;
total fluorine (F): 6-25;
wherein
a combined concentration of RO is in a range from 1.5 to 17, and
a combined concentration of R′₂O is in a range of from 0.75 to 8.

22. The glass of claim 1, wherein the glass comprises in mole percent on the oxide basis and the fluorine content:
P₂O₅: 52-68;
SiO₂: 4.75-25;
Al₂O₃: 3.5-4.5;
Li₂O: 0.3-3;
K₂O: 0.6-4;
ZnO: 0.75-14;
SrO: 0.75-4;
CuO: 7-14;
Sb₂O₃: 0.1-0.1;
CeO₂: 0.3-0.9;
total fluorine (F): 10-20;
wherein
a combined concentration of RO is in a range from 2 to 14, and
a combined concentration of R′₂O is in a range of from 1 to 6.

23. The glass of claim 1, wherein the glass has a red-shifted cutoff wavelength having at least 50% transmittance at a thickness of 0.21 mm is at least 635 nm or longer.

24. The glass of claim 23, wherein at a thickness of 0.21 mm, the glass has a transmittance higher than 85% at wavelengths in a range of 425-465 nm, a transmittance higher than 87% at wavelengths in a range of 466-560 nm, a transmittance lower than 5% at wavelengths in a range of 750-800 nm, and a transmittance lower than 10% at a wavelength of 1,200 nm.

25. An article comprising the glass of claim 1.

26. The article of claim 25, wherein the article is an optical filter for filtering near infrared light.

27. A method for producing the glass of claim 1, comprising mixing and melting raw materials in mole percent on the oxide basis and by the fluorine content.

28. The method of claim 27, wherein a raw material for the total fluorine is selected from the group consisting of AlF₃, SrF₂, ZnF₂, LiF, KF, or any combination thereof.
